(19) United States
(12) Patent Application Publication
(10) Pub. No.: US 2025/0091152 A1
(43) Pub. Date: Mar. 20, 2025

(54) Process electronic welding network

(71) Applicant: Werner Fassler, Rochester, NY (US)

(72) Inventor: Werner Fassler, Rochester, NY (US)

(21) Appl. No.: 18/831,170

(22) Filed: Aug. 26, 2024

Related U.S. Application Data
(60) Provisional application No. 63/628,861, filed on Aug. 29, 2023.

(51) Int. Cl. B23K 9/095

(52) U.S. Cl. CPC B23K 9/0956; B23K 9/0953

(57) ABSTRACT

A welding network includes processing electronics responsive to a welding scene for providing information related to the welding scene.

### CROSS REFERENCE TO RELATED APPLICATIONS

This application claims the benefit of and priority to U.S. Provisional Application No. 63/628,861, filed Aug. 29, 2023, the disclosure of which is hereby incorporated by reference in its entirety for all purposes.

### FIELD OF THE INVENTION

This invention relates generally to the field of welding either by a welder or an automated system.

### BACKGROUND OF THE INVENTION

Fusing metals together requires heat to liquefy metals with a welding plasma arc (high energy density) that produces a blinding illumination and splutters materials during the fusion process. A welding helmet is often in the form of a face shield attached with a pivot on a head band. The helmet is used to shield the welder's eyes and face from damage by welding brightness and splatter. The helmet has a viewing opening with a filter protecting the human eyes from proximity of about 100-300 mm (4-12 inches) distance to the bright welding arc plasma generated with small to large industrial welders.

Prior helmet structures use a dark gray filter strong enough to protect the welder's eye from the blinding welding arc plasma. The gray scale filtering causes considerable detail losses of the image. That loss of visual quality and detail requires the welder to possess skills such as artisanship and artistic abilities to overcome the filters degrading effects to produce a quality weld. An ambient illuminated image is invisible through a helmet filter protecting the welder's eyes from the welding arc plasma illumination. To find the welding starting point guessing from memory or preposition the welding electrode are the choice left to a welder.

To circumvent the illumination difference between ambient and welding arc plasma and enable visibility in the ambient condition, a protective filter is used with a helmet headband pivot to enable an up position for ambient viewing and a helmet shield down for welding the arc plasma. The up position facilitates viewing the ambient illumination to locate and start the welding arc plasma. Starting the welding arc plasma requires a quick head-flip, or quickly placing the helmet face shield manually in front of the welder's eyes. In the down position the welder's view changes from unrestricted ambient viewing to view the welding arc plasma light filtered.

Many welding helmets are equipped with liquid filter that has with a high transmission for ambient and changes, by sensing the welding arc, the filter density to enable viewing of the weld.

All types of filters are a compromise. Welding with the radiation generated by the welding arc plasma passing through a filter will leak damaging radiation that is harmful to the human eyes and face. Liquid filtering for protection of the welder's eyes and face with the short raw exposure at high transmission and the continuous radiation passing through the filter from the welding arc plasma also exposes the welder's face and eyes to unwanted and accumulating radiation.

### SUMMARY OF THE INVENTION

An embodiment shown in FIG. 7 has processing electronics to manage a welding network and furthermore connect to a community of welding networks with a data center (cloud) and artificial intelligence to manage welding.

In FIG. 7 another embodiment shows the schematic of a welding network, for data analysis to operate the welding network, and produce an unobstructed observable standard video of welding to be displayed on a viewing screen for welding.

### BRIEF DESCRIPTION OF THE DRAWINGS

In the detailed description of the preferred embodiments of the invention presented below, reference is made to the accompanying drawings, in which:

FIG. 1 is an isometric view from the welder's perspective viewing the inside of a helmet (13) having at least one pixilated viewing screen (5) attached to the back of an insert. FIG. 1a is an isomeric view of an embodiment seen from the welder's side of an insert with an extension, a mounting frame being part of the insert.

FIG. 2 is an isomeric drawing of an embodiment from the welding side of a helmet (13) embodiment. FIG. 2a is an isometric drawing of an embodiment seen from the welder's side of an insert with an extension, and a mounting frame being part of an insert. FIG. 2b is an isomeric drawing of a liquid crystal filters (9) helmet (13) having a liquid crystal filter (9) in front of the image sensor.

FIG. 3 is an isomeric drawing of a welding helmet (13) and an embodiment of the insert shown in (FIG. 1 and FIG. 2) incorporated into the welding helmet (13). A sensors array (11) is shown evaluating different welding parameters for displaying and adjustments in real time. FIG. 3a is an isometric drawing that shows a helmet (13) with the extended insert.

FIG. 4 is an isometric view of a helmet (13) insert embodiment. The isometric drawing presents an embodiment of optical image gathering to project images for capture with a pixilated image sensor (17). There are 4 single lens barrel designs to view the ambient and the plasma arc picture.

FIG. 5 is an isometric sectional view of the insert's (1) elements. FIG. 5a is an isomeric drawing of an insert (1) that shows a filter and f-stop aperture (15) selection wheel (37) driven by an actuator (38) to select the f-stop aperture (15), filters (9), or a combination of both with the filter aperture selection wheel (37) for viewing the ambient and the welding arc light images. FIG. 5b is an isomeric cross section drawing of insert (1) with a f-stop's aperture, and/or filter selection wheel (37) including the lens barrel assembly (21).

FIG. 6 is an isomeric cross section taken along centerline (12) showing an implementation of a system having a stationary lens barrel assembly (21) to view ambient and the welding arc plasma images. FIG. 6a is an isomeric view of an alternate simplified implementation for a stationary system. This embodiment shows three parts, the lid (4), the printed circuit board (49), and the box (3).

FIG. 7 shows a schematic diagram of the printed circuit board (49) to operate a video welding helmet (13) powered by disposable, rechargeable batteries, or an AC plug in power supply (62) with adequate wattage to power the helmet's (13) electronics. FIG. 7a is a schematic diagram of a welding network showing another embodiment. FIG. 7b is an isomeric drawing that shows an embodiment for bridging human limitation of manipulating welding with electrodes.

FIG. 8 is a schematic diagram of a welding network showing different embodiments. FIG. 8a is an isometric drawing showing eyeglasses (81) that compensate for the viewing stresses caused by the “close” proximity of a pixilated viewing screen (5). FIG. 8b is an isomeric drawing showing a welder with installed lenses (19) inside the welder's helmet (13) for viewing the pixilated viewing screen (5). FIG. 8c is an isometric drawing that shows how a flexure (92) adjusts the position of the pixilated viewing screen (5) for changing the distance (72) to the welder's eyes (73) and (73a).

FIG. 9 is an isomeric drawing of a welding helmet (13) that solves the problem of the extreme lighting/exposure difference, between welding arc plasma and ambient lightening by use of two lens barrel assemblies (21), one projecting ambient and the second a welding arc plasma video on a pixilated image sensor (17).

### DETAILED DESCRIPTION OF THE INVENTION

The present description will be directed, in particular, to elements forming part of, or cooperating more directly with, apparatus in accordance with the present invention. It is to be understood that elements not specifically shown or described may take various forms well known to those skilled in the art. In the following description and drawings, identical reference numerals have been used, where possible, to designate identical elements.

The example embodiments of the present invention are illustrated schematically and not to scale for the sake of clarity. One of the ordinary skill in art will be able to readily determine the specific size and interconnections of the elements of the example embodiments of the present invention.

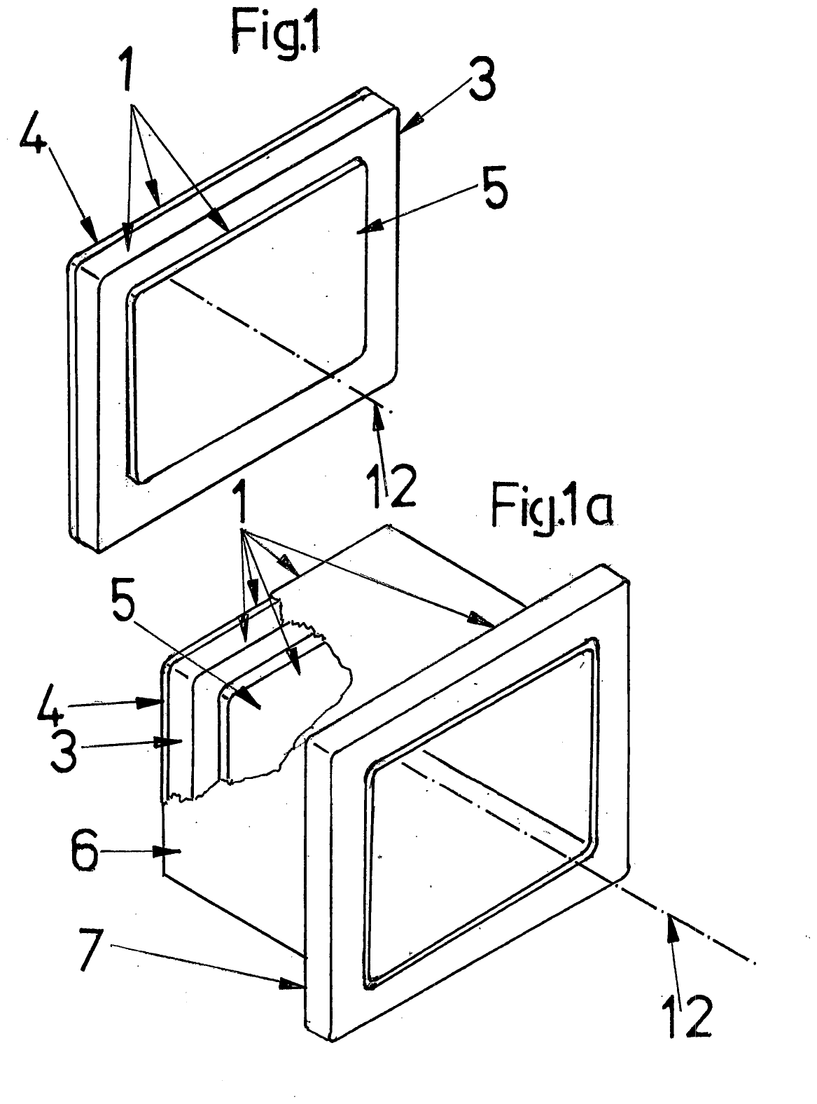

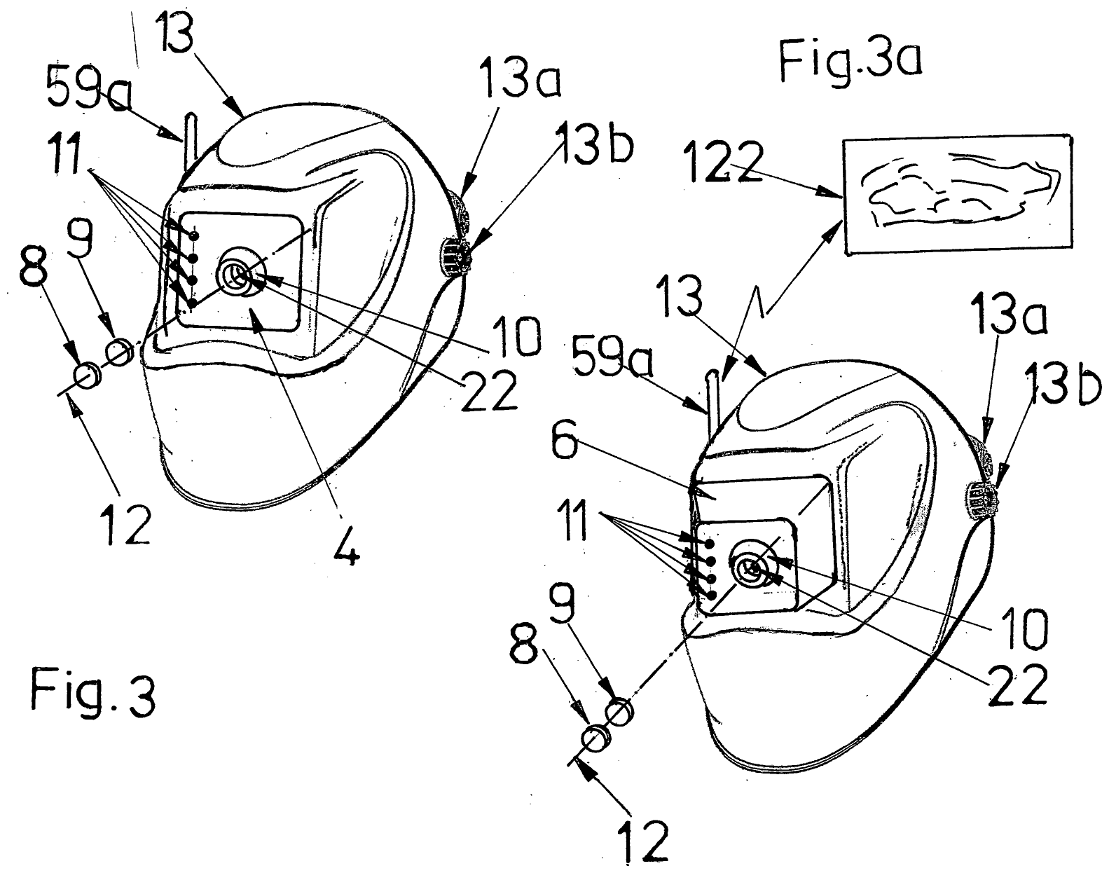

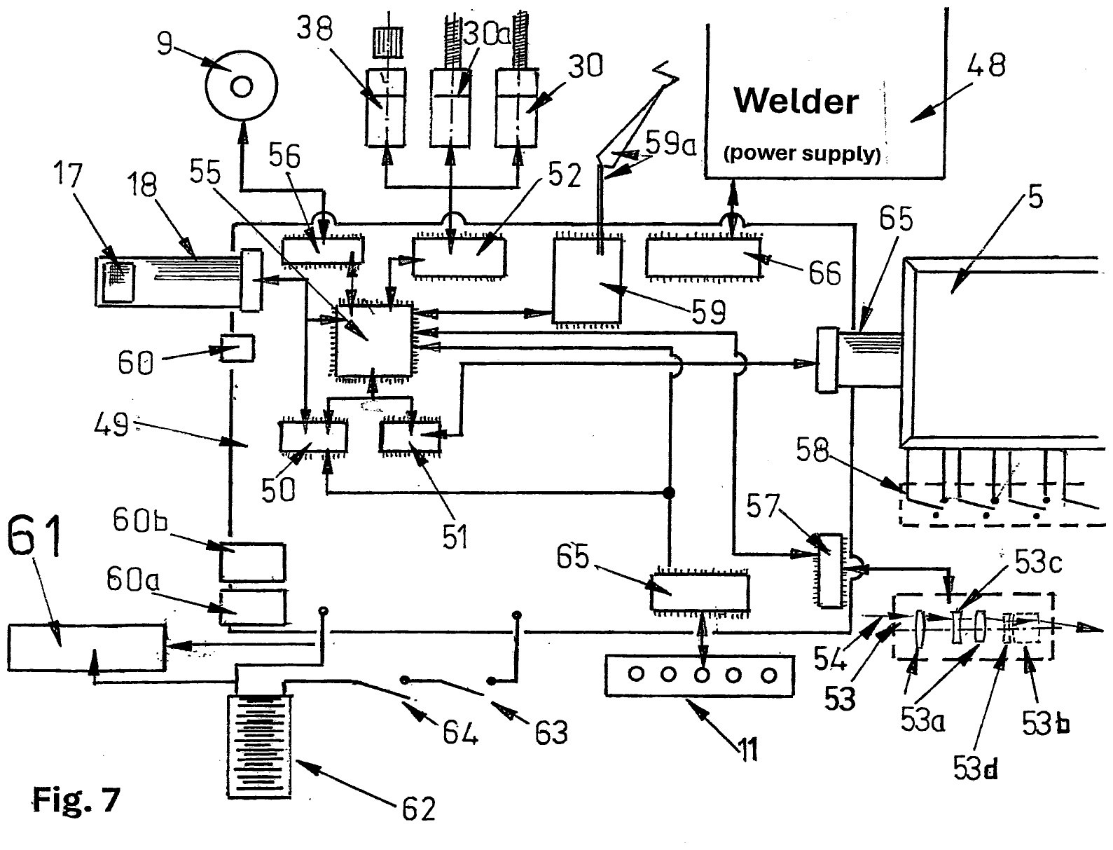

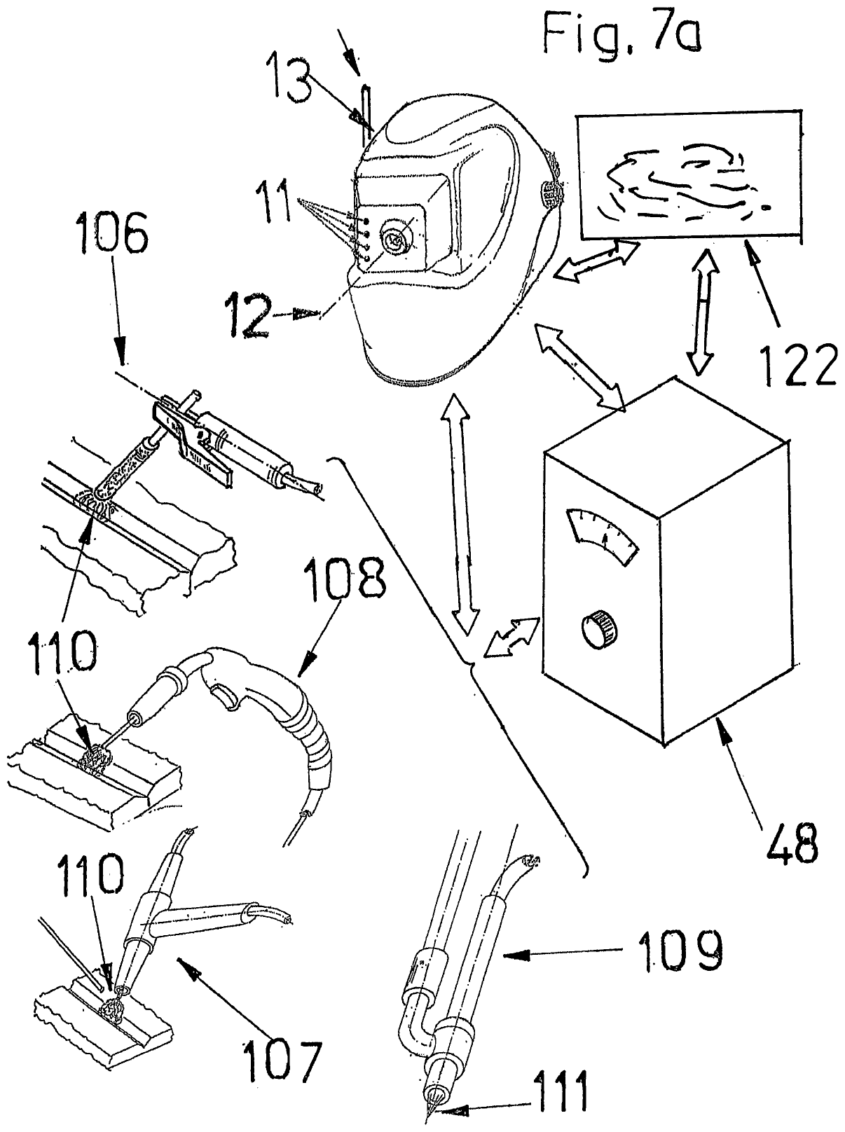

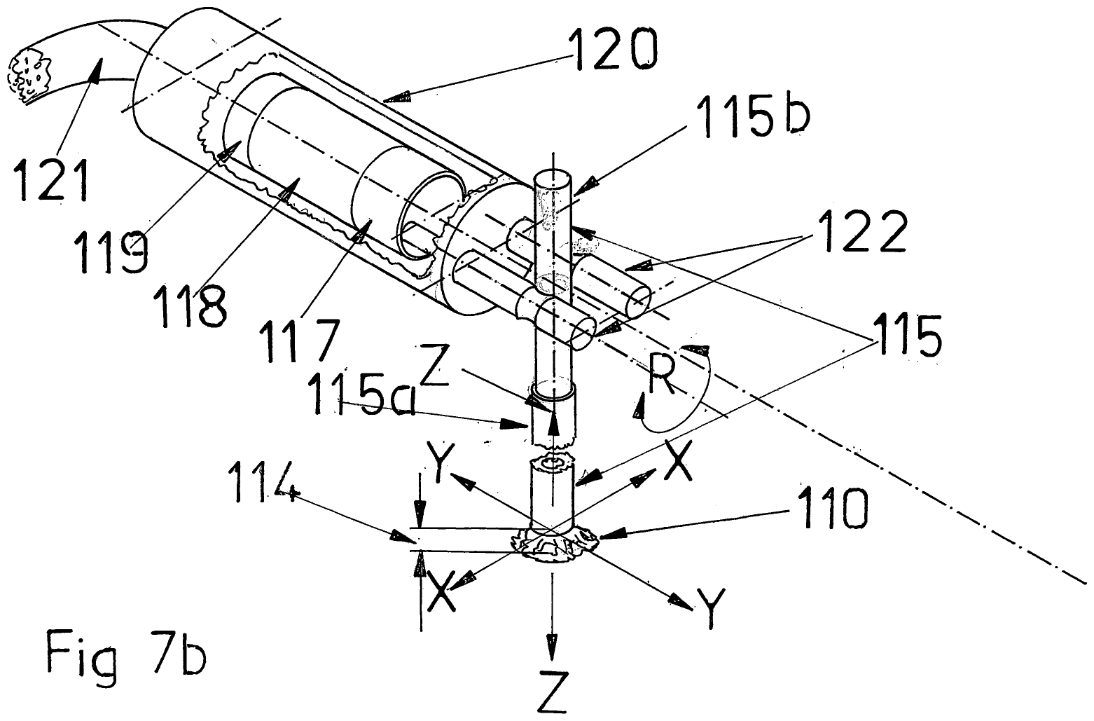

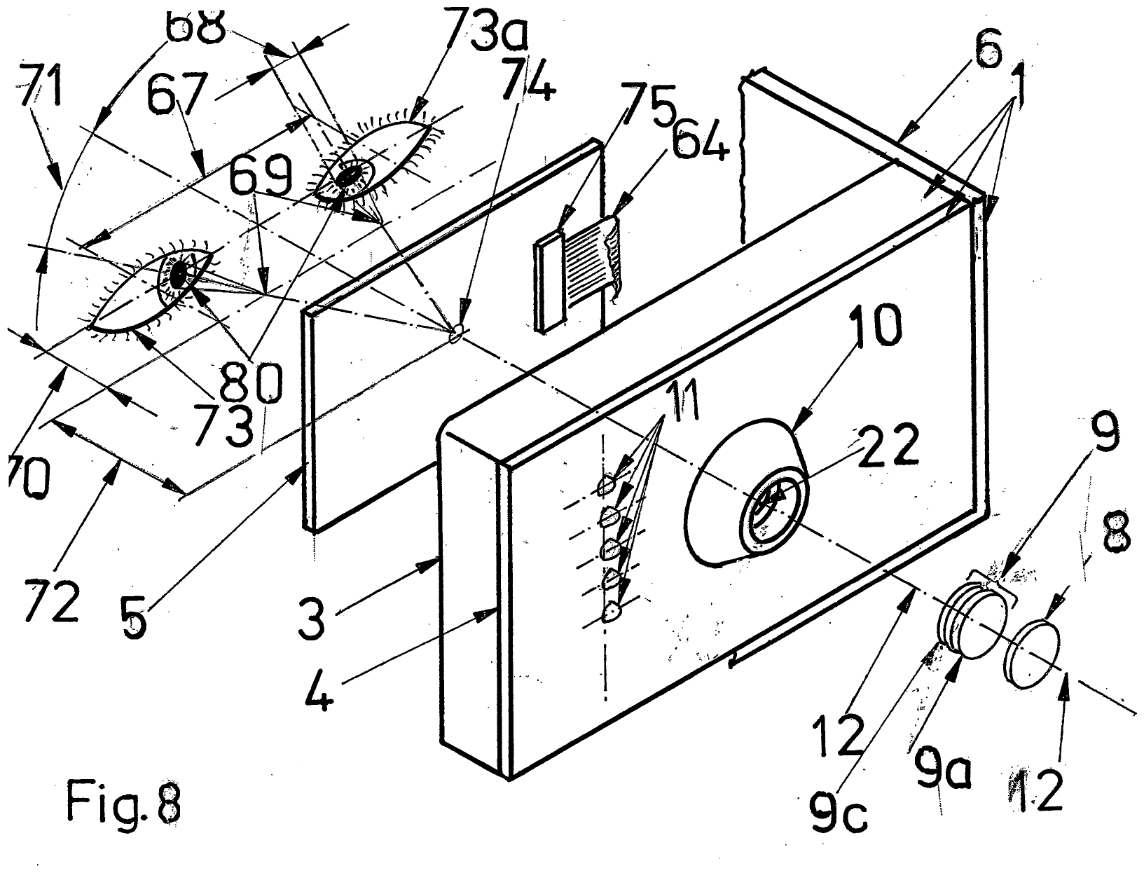

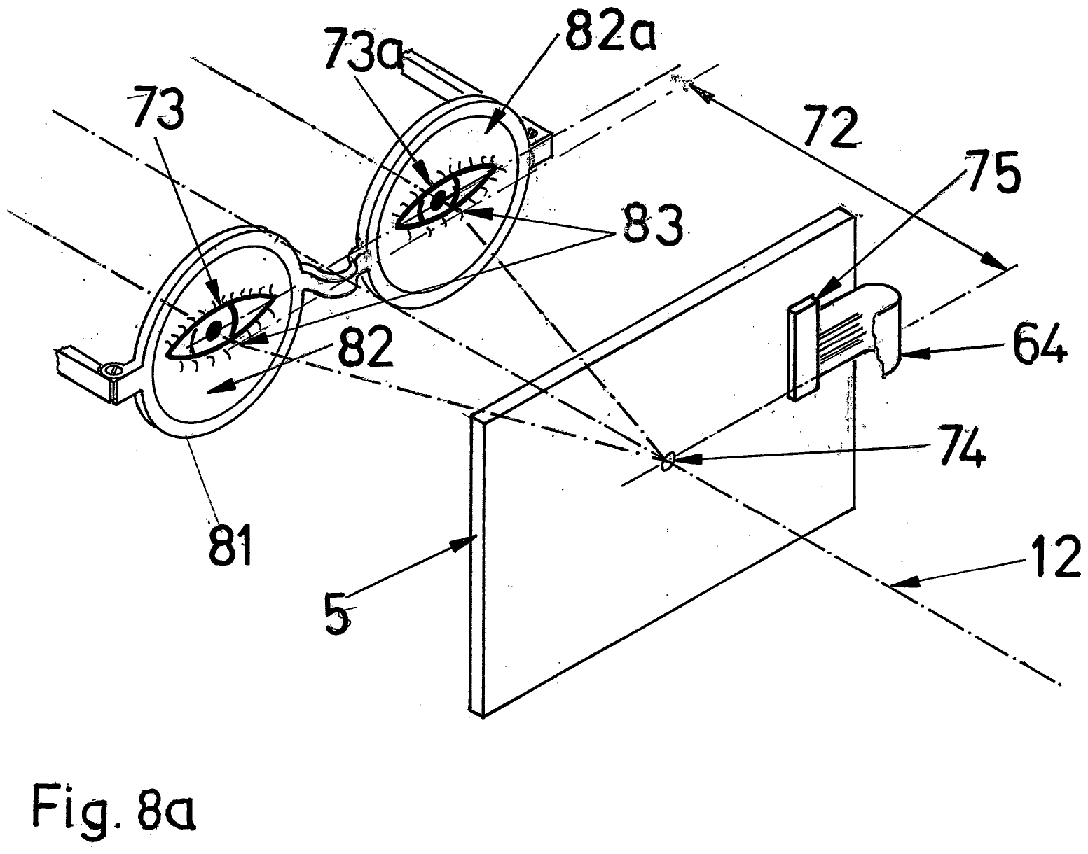

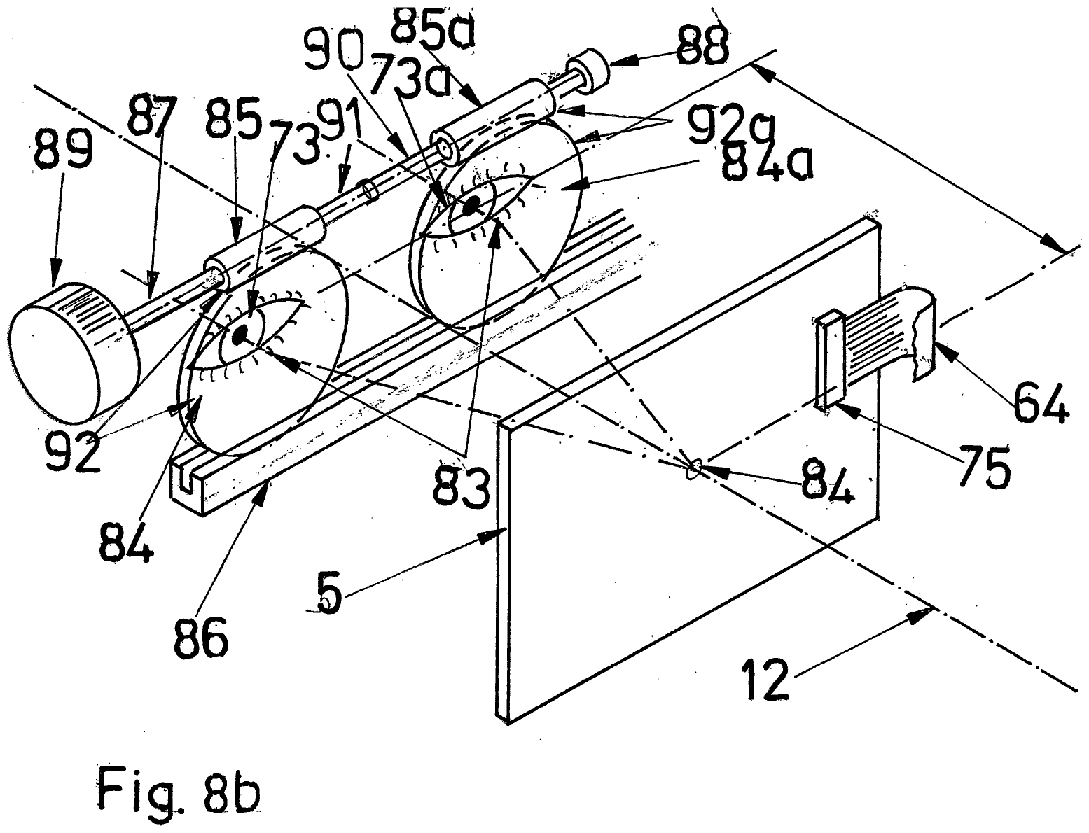

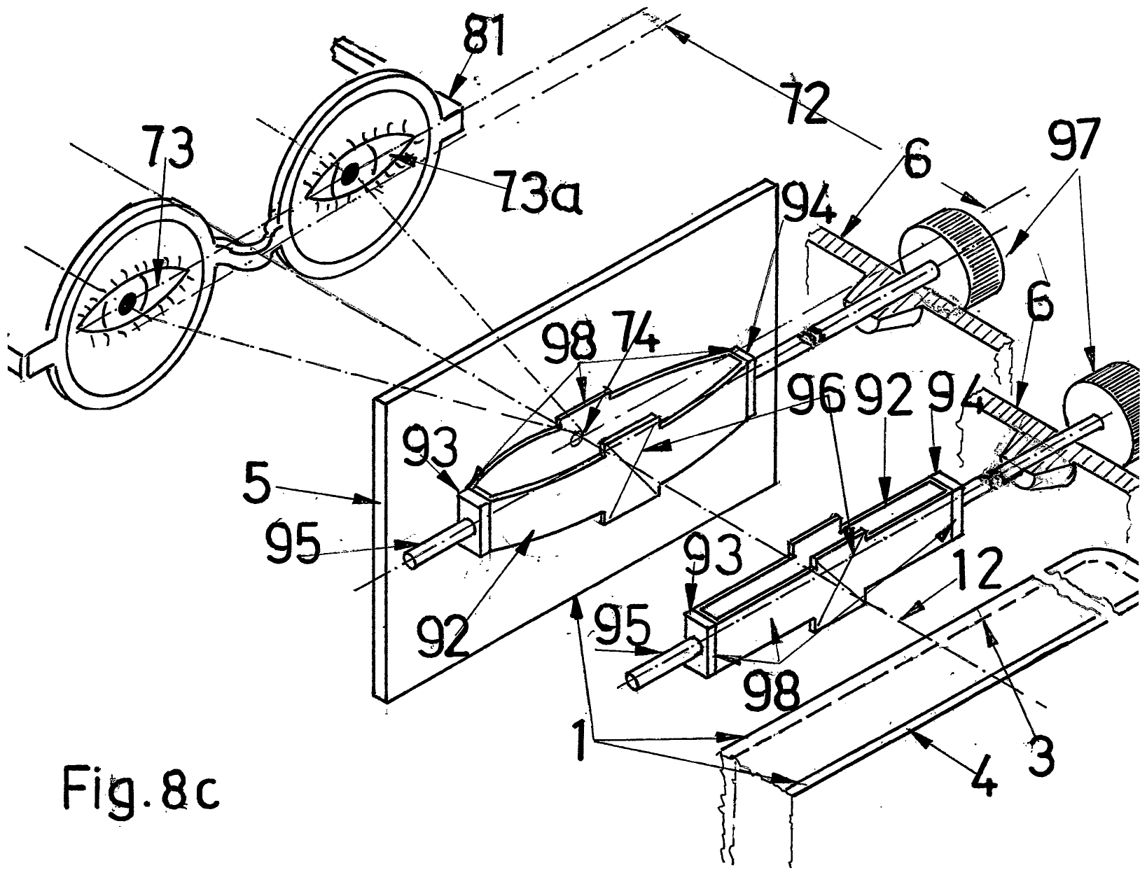

FIG. 1 shows an isomeric drawing of an embodiment including an assembled insert (1) without the welding helmet (13 see FIG. 3) viewed from the welder to assists the viewing of welding with the human eyes (73 and 73a see FIG. 8) who are limited by reaction speed for moving objects, illumination (pupil aperture), and focus (culinary muscle) for distance variation adjustments, that results in image degradation of welding images of the welding plasma arc (110 see FIG. 7a) image in real time. By using short focal lenses, high-speed integrated circuits, and electronic image processing those shortcomings are eliminated presenting a clear and steady real time image of brightness, contrast, and high-resolution to a welder.

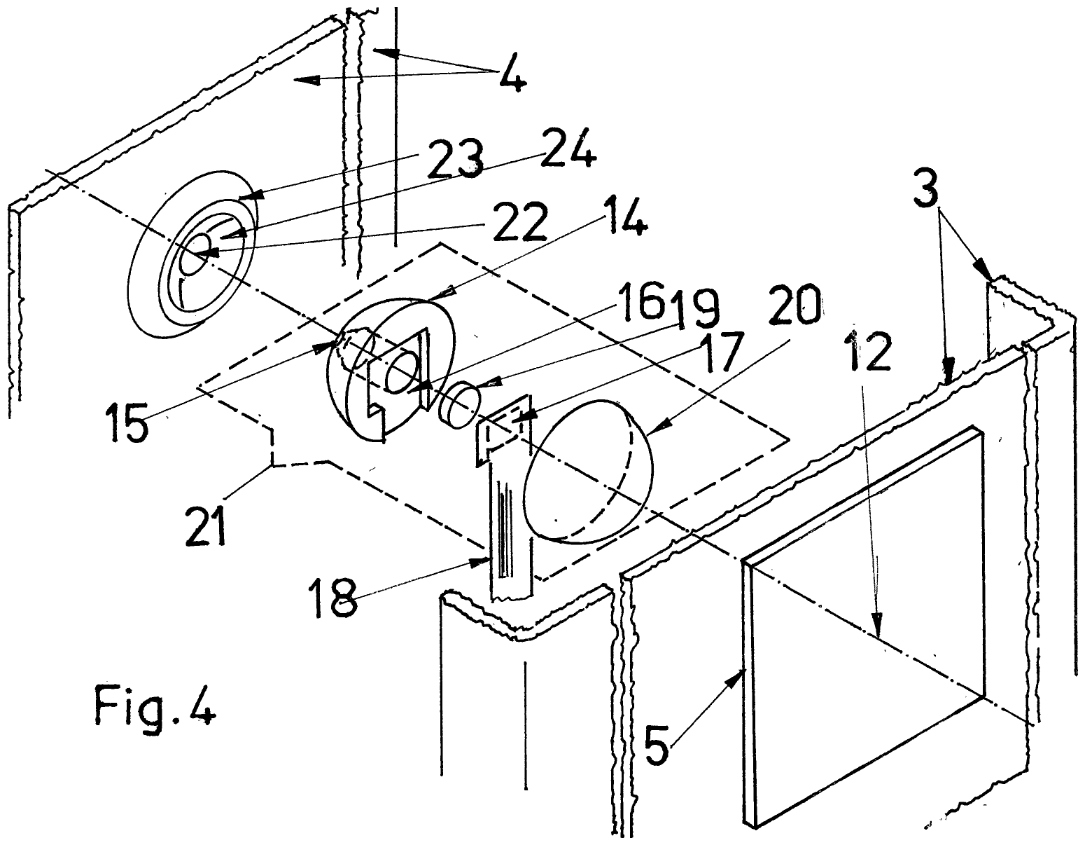

The welder views a pixilated viewing screen (5). The insert (1) is in the form of a box (3) closed with a lid (4). Assembled to the rear of box (3) is at least one pixilated viewing screen (5). The box (3) with a lid (4) and the pixilated viewing screen (5) are assembled into a welding helmet (13 see FIG. 3.) along an optical center line (12). The welder views the pixilated viewing screen (5) to observe the welding in ambient and in the welding plasma arc (110 see FIG. 7a) mode. The welding plasma arc (110 see FIG. 7a) viewing is triggered with the bright light of the welding plasma arc (110 see FIG. 7a). The insert (1), box (3) and lid (4) are manufactured from a suitable metallic material and contain the mechanical, electronic, and optical parts, as will be discussed later see (FIGS. 4,5, 5a, and 6, 6a) to protect the sensitive electronics from radiation, especially electromagnetic radiation, heat, and weld splutter.

Commercially available welding helmets have an opening for a liquid crystal filter which can (conveniently) receive insert (1). The insert (1) in this embodiment is as a video viewing replacement for the liquid crystal filter that is common in welding helmets (13 see FIG. 3). Insert (1) is mounted into a welding helmet (13 see FIG. 3) to provide detailed and complete protection for viewing the welding arc plasma. The minimal (see FIGS. 8, 8a, 8b, and 8c) distance (72) between the welder's eye and the pixilated viewing screen (5) is shown for helmets (13) with a sufficient viewing distance (72 see FIG. 8). Many alternate inserts (1) or helmets (13) embodiments will suggest themselves to those skilled in the art.

FIG. 1a is an isomeric drawing of a welding insert (1) with an extension (6) as an added part to the insert (1). The insert (1) of (FIG. 1a) is assembled into the end of the extension (6). A corner of the isomeric drawing has been removed to show the insert (1) in (FIG. 1a). The rear frame (7) part of extension (6) can be dimensioned to fit the slot left open to replace the standard viewing liquid crystal filters from a helmet (13). The distance (72) from the welder's eyes (73) and (73a) to the pixilated viewing screen (5) will be discussed in (FIG. 8)

The mounting frame (7) in this embodiment is designed to fit the standard liquid filters (9) mounting slot of welding helmets. Insert (1) with extensions (6) accommodate the viewing distance (72 see FIG. 8) to the pixilated viewing screen (5) from the welder's eyes (73 and 73a see FIG. 8). The optical center line (12) for the imaging system is also shown.

According to an example embodiment of the invention, the welding system includes a helmet worn by a welder. The helmet includes a screen viewable by the welder that provides information related to the welding scene. In some example embodiments, the welding system includes means for protecting the welder and electronics from the welding process including, for example, means for providing protection from weld splatter and radiation for the welder and electronics. In some example embodiments, described in more detail herein, the processing electronics includes means for assisting the welder's sight and means for analyzing welding speed and position accuracy limitations. In other example embodiments, described in more detail herein, the processing electronics associated with the image sensor includes artificial intelligence, for example, an AI chip included with the processing electronics or connected via a network, for analyzing the welding scene in real time. This information, related to the welding scene, is provided to the welder. Network examples include, but are not limited to wired, wireless, LAN, or cloud based.

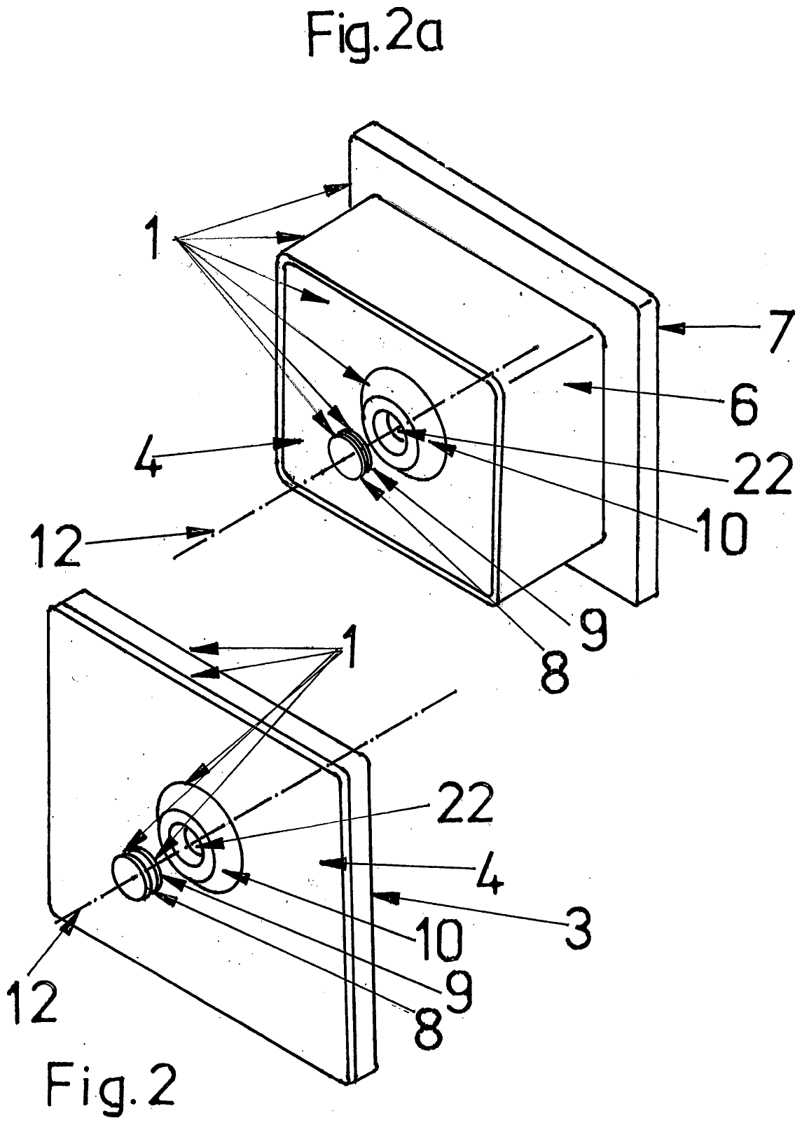

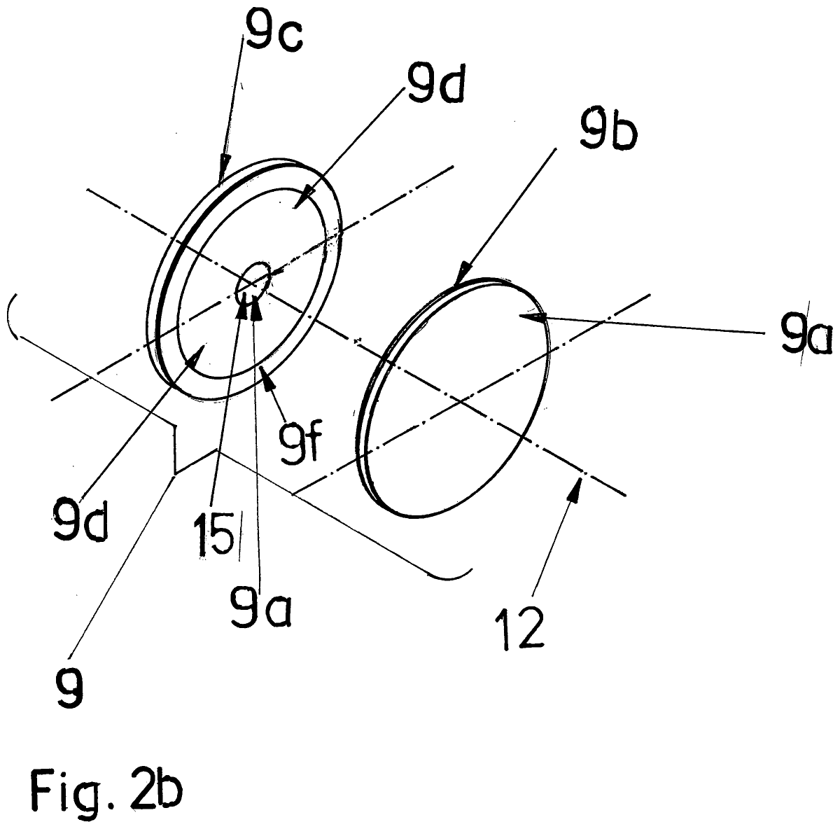

FIG. 2 is an isometric drawing that shows a helmet (13 see FIG. 3) embodiment with an insert (1) viewed from the welding side. A protrusion (10) extends from the front of the cover (4) to secure in place a disposable transparent protector (8) and filters (9). A small liquid crystal filter (9 see FIG. 2b) adds real time filtering flexibility. Heat filtering added to filter (9) reduces the welding arc plasma (110 see FIG. 7a) heat energy from saturating the pixilated image sensor (17 see FIG. 4). Coating of filter (9), and lenses (19 see FIG. 4) reduces glare and other radiation from the welding scene. A liquid crystal filter (9 see FIG. 2b) real time adjustment to compensate for ambient, and distance induced illumination variations by the welding plasma arc (110 see FIG. 7a) projected on the pixilated image sensor (17 see FIG. 4). Liquid crystal filters (9) are adjusted by selecting a potential (voltage) tension to compensate brightness changes. Exchangeable single disk filters (9) accommodate different welding needs such as material choices, and welding techniques, such as gas, stick welding.

The disposable transparent protector (8) can be formed from any transparent material such as glass, plastic, or quartz that maintains optical image integrity. The disposable transparent protector (8) protects the imaging optics (19 see FIG. 4) the filter (9) and the pixilated image sensor (17) from radiation and weld splatter. The disposable transparent protector (8) is conveniently shown as a circular embodiment.

The insert (1) fits helmet (13 see FIG.) where the viewing distance (72 see FIG. 8) is sufficiently corrected with lenses (see FIG. 8) without need for an extension (6) part of insert (1) for helmets (13) between the welders's eye (73 and 73a see FIG. 8) to the pixilated viewing screen (5). The aperture (22) permits image transmission.

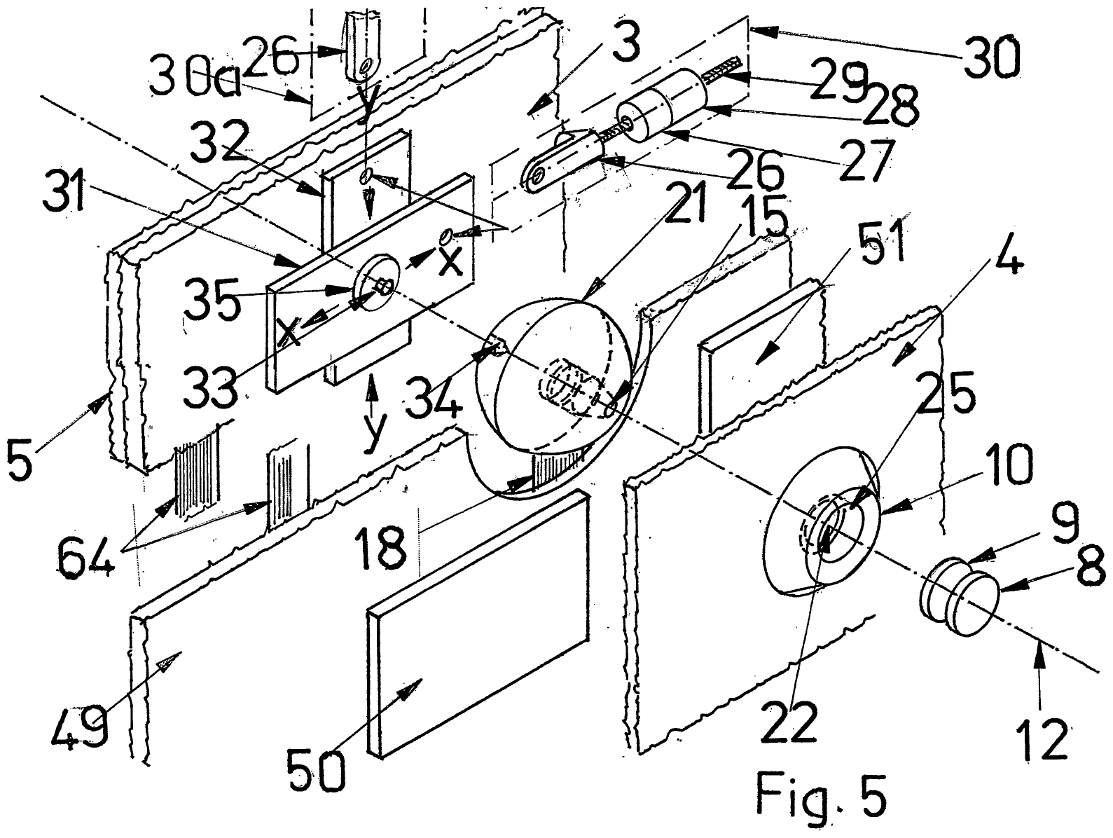

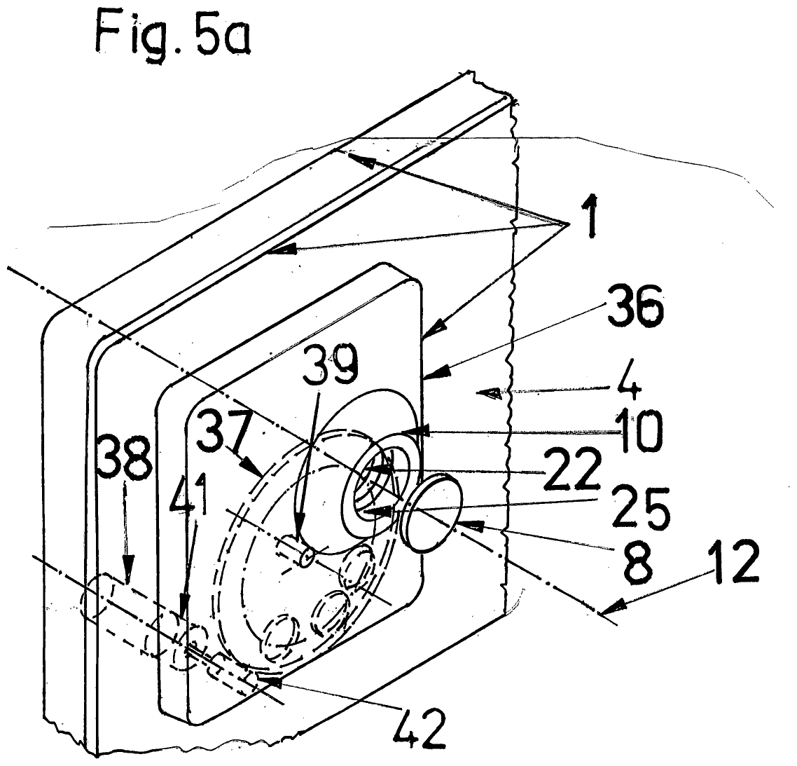

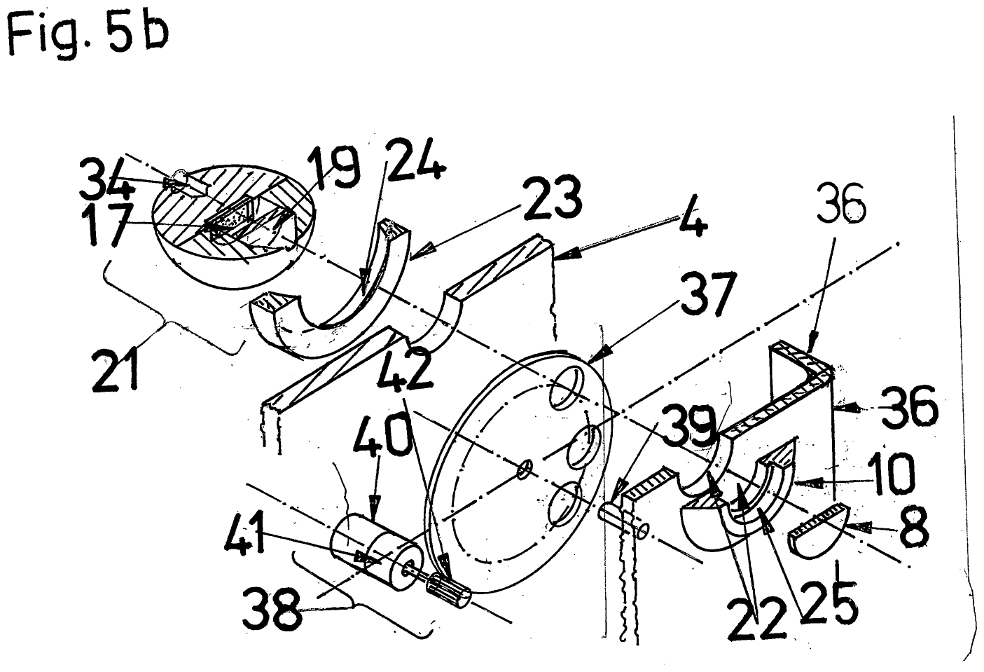

FIG. 2a is an isomeric drawing that shows the view from the welding site with an extension (6) and a mounting flange (7) as part of the insert (1) to extend viewing distance (72 see FIG. 8) to pixilated viewing screen (5). The electronic, mechanical, and optical parts (see FIGS. 4 and 5) are part of the insert (1) assembly. The disposable transparent protector (8), the filter (9), the protrusion (10), with image transmission aperture (22) and the optical center line (12) are also shown.

The insert (1) with extension (6) fits helmet (13 see FIG. 3) where the distance (72 see FIGS. 8, 8a, 8b and 8c) needs to be extended with an extension (6) to providing a minimal viewing distance for the welder's eyes (73 and 73a see FIG. 8) to the pixilated viewing screen (5) to enable the welder to focus on the pixilated viewing screen (see FIGS. 8, 8a, 8b, and 8c) showing correction embodiments for close up focusing without strain.

According to an embodiment of the invention, the welding system includes processing electronics having real time adjustable liquid filtering means. FIG. 2b is an isomeric drawing that shows a liquid crystal filter (9) in circular format in line with the optical center line (12). A liquid filter (9) adds real time filtering adjustments for matching the dynamic range of an image to match the pixilated imaging sensor's (17) range. (9a) and (9c) are two transparent disks with active transparent conductive metal coating such as indium tin oxide (9b and 9d). The passive (ground) coating (9b) and the active coating (9d) in this embodiment is patterned with an aurora (9f) and an f-stops aperture (15). The two transparent glass disks (9a) and (9c) are coated for heat and radiation protection and management. Another embodiment uses conductive transparent metals pixels (grayscale, or red, blue, green) to enable f-stop aperture (15) and aurora (9f) size, filtering, density, and chromatic selection to address exposure and imaging needs.

FIG. 3 is an isomeric drawing of a helmet (13) with insert (1) an embodiment worn by a welder, the helmet includes network connection (see FIG. 7), a viewing screen viewable by the welder, the screen (5) displays a data fabricated standard video including welding information of the welding scene. An embodiment for protecting the welder and electronics by managing welding radiation and material splatter common to welding, an embodiment where the processing electronics includes means for capturing image data information on a requirement basis for updating imaging and data to fabricate the standard video for viewing an unobstructed welding scene.

In an embodiment the processing electronic captures sensor data on a requirement basis for accurate and proficient operation of the welding network.

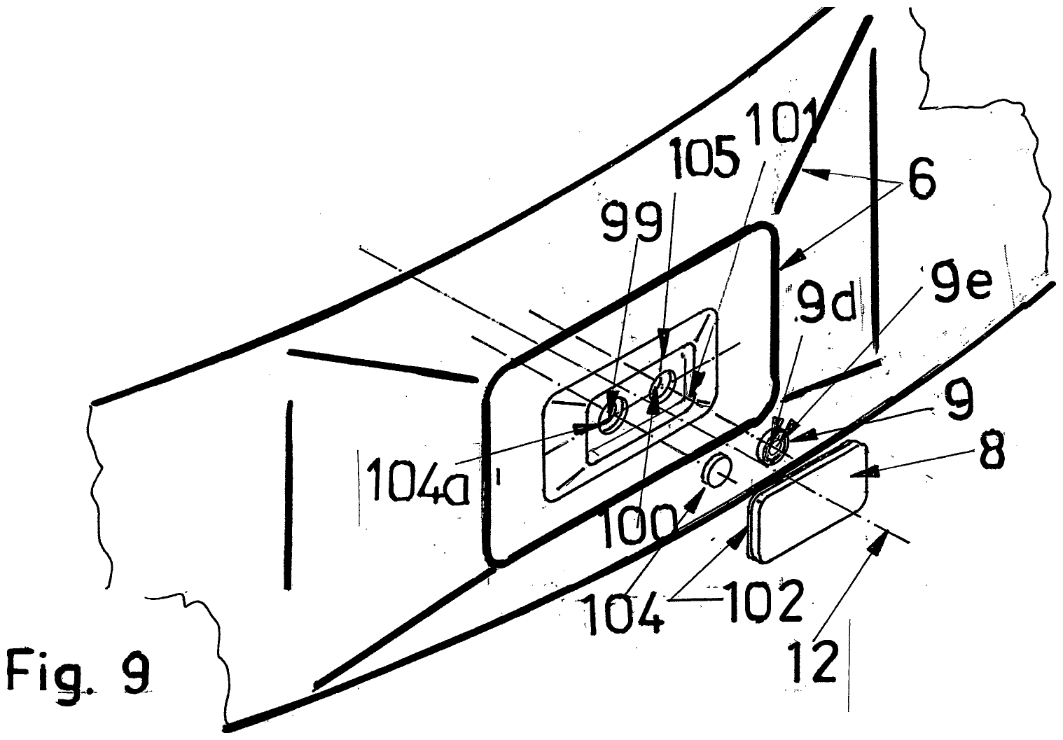

The isomeric drawing includes a sensor array (11 see FIG. 7) that is used to collect information not extractable from the pixilated image sensor (17 see FIG. 4.) During ambient viewing of the welding scene the pixilated image sensor (17 see FIG. 4) with sensors from array (11) real time ambient exposure information is adjusted memorized and utilized for image superimposition (see FIG. 9) and then as a standard video presented on the pixilated viewing screen (5 see FIG. 1). Real time welding arc plasma (110 see FIG. 7a) image information extracted from the pixilated image sensor (17 see FIG. 4) and the sensor array (11) before and during welding by recognize the ignition of the welding arc plasma (110 see FIG. 7a) or by recognizing the welding gap dimension (see FIG. 7b) to trigger welding, and the network exposure alterations to capture images within the dynamic range of the pixilated image sensor (17 see FIG. 4) then with electronic processing show the welder a fabricated data based standard video adopted to human sight enabling unobstructed viewing of the welding process. The combined sensor information of sensor array (11) the pixilated image sensor (17 see FIG. 4) An embodiment where the processing electronics analyses the collected data to set up and operate the welding network for automation and instructing a welder with a fabricated standard video for the local network (see FIG. 7a) An embodiment communicates with a data center to benefit from communal data and artificial intelligence (122) with welding information to aid welding and override automatically through adjustments to maintain welding uniformity and quality.

According to an embodiment of the invention, the pixelated image sensor (17) provides image information of the welding seam that can be used by processing electronics to predict images for assembling a standard video frame. In another example embodiment of the invention, the processing electronics includes means for capturing image frame information for updating information related to the welding scene.

The embodiments of wired and wireless network connectivity, collected data can be transmitted with antenna (59) to a communal data center (122) for storage. The collected welding information over time analyzed by AI will provide improving data to be utilized for improving welding quality, and productions. In an embodiment the welding network process electronics communicates with the data center to benefit from communal data and artificial intelligence.

Another sensor of the array (11), or information extracted from a pixilated image sensor (17, see FIG. 4) initializes real time magnification by the start of the welding plasma arc (110 see FIG. 7a). Sensor or sensors from array (11) and the pixilated image sensor (17) provide real time information and images on the pixilated viewing screen (5) such as, temperature, power consumption, chromatic weld bubble information, instructions for welding motion, patterns suggestions, speed, data, and standard videos with data-based image predictions to show a welder detailed welding progress in a standard video frame rate.

The pixilated image sensor (17) that captures the welding scene image electronically partitioned detects the position of the welding plasma arc (110 see FIG. 7a) and the geometry of a welding seam then electronically (see FIG. 5) centers the image on the pixilated viewing screen (5) and add the information to the network. Also shown is the protrusion (10), the optical center line (12), the lid (4), aperture (22) the disposable transparent protector (8) with a filter (9) and a wireless antenna as an embodiment of wired and wireless network connectivity.

It should be understood multiple different embodiments of inserts (1) can be used with this invention.

FIG. 3a is an isomeric drawing of a helmet (13) showing a helmet (13) insert (1) an extension (6), headband (13a), and pivot (13b), the disposable transparent protector (8), filter (9), protrusion (10), aperture (22) along optical center line (12). Extension (6) expands the distance (72 see FIG. 8) from the welder's eyes (73 and 73a) to the pixilated viewing screen (5) accommodating human focus (average focal length of the human eye is approximately 20 mm f2=xx′) for short object distances (72 see FIG. 8). and sensor array (11 see FIG. 3 and FIG. 7).

The insert (1) includes not shown, the process electronics (see FIG. 7) imaging optics, (see FIG. 4) mechanics (see FIGS. 4 and 5), at least one pixilated imaging sensor (5 see FIG. 4) for image capture, at least one pixilated viewing screen (5 see FIG. 1) for image viewing (See FIGS. 8, 8a, 8b, and 8c). Assembling those parts inside an insert (1) are part of a helmet (13) and constitute the helmet (13). The helmet (13) is equipped with the pixilated viewing screen (5) and optics (see FIG. 8b) for the welder part of the helmet (13) accommodates short distance viewing of the pixilated viewing screen (5).

The large energy (illumination or dynamic range difference) between ambient and welding arc plasma is compensated, for example, by programming image capture for the pixilated image sensor (5 see FIG. 4); electromechanical actuators changing the f-stops aperture (15) and filters (9) (see FIG. 4); special liquid crystal filter (9b see FIG. 2b); or ambient only imaging lens barrel assembly (21 see FIG. 4) embodiments.

With a multitude of cameras (see FIG. 4) specially adapted to various welding scenes such as ambient, and welding methods such as stick, (106 see FIG. 7a), TIG (107 see FIG. 7a), MIG (108 see FIG. 7a), laser (109 see FIG. 7a).

An embodiment where a special video system is attached to the arc producing welding tool such as Stick (106 see FIG. 7a), TIG (107 see FIG. 7a), MIG (108 see FIG. 7a), and laser (109 see FIG. 7a); the hand tool is commonly known as a welding gun. Proximity narrows the dynamic range of the plasma arc (110 see FIG. 7a) and with magnification provides a large plasma arc (110 see FIG. 7a) picture for detailed observation of the welding scene.

According to an example embodiment of the invention, a welding network includes processing electronics responsive to a welding scene for providing information related to the welding scene. In some example embodiments of the invention, the welding system includes a pixilated image sensor. The processing electronics provides real time viewing of the welding scene on the pixilated image sensor. In some example embodiments, this includes optic means for projecting the welding scene image onto the pixilated image sensor. Optic means can include, for example, prismatic optics or multiple pixilated image sensors with corresponding imaging optics for superimposing one of a plasma arc welding image and a weld puddle welding image onto an ambient image. In another example embodiment, optic means can include a biased lens system for bridging the exposure energy of an ambient scene and the welding scene. The lens system can include an optical filter and at least one focusing aperture. When the lens system includes an optical filter and at least one focusing aperture, some example embodiments include multiple image sensors with the biased lens system including multiple lenses for bridging the exposure energy of the ambient scene and the welding scene. In other example embodiments, the welding system can include multiple image sensors and a lens system including multiple lenses for bridging the exposure energy of an ambient scene and the welding scene. The welding system can be part of a network. Network examples include, but are not limited to, wired, wireless, LAN, or cloud based. In other example embodiments, the processing electronics includes means for independent image and sensor data capture and means for interpreting the data.

FIG. 4 is an isomeric drawing in correspondence with claim 3 is an embodiment of short focal length image projection optics (21) and a pixelated image sensor (17) for capturing data incorporated in a spherical lens barrel assembly (21) for capturing the ambient, and welding arc plasma scene images to project them on to a pixilated image sensor (17 see FIG. 1). The optical systems centerline (12) part of FIG. 4, the helmet (13 see FIG. 3) capture optics (19) part of lens barrel assembly (21) projects images onto the pixilated image sensor (17). Processing electronics for image capture in this embodiment (see FIG. 7), a pixilated viewing screen (5 see FIG. 1) assembled to the insert (1), in the helmet (13) is between the welder and the welding plasma arc (110 see FIG. 7a) and will completely protects the welder from damaging radiation and weld splatter. The image capture hardware presents a small front with a lens (19), and the illumination filters (9) to be protected from splatter, radiation, and specifically from electromagnetic radiation by the disposable transparent protector (8 see FIG. 2). A coating with a transparent metal such as indium tin oxide for electromagnetic radiation on the disposable transparent protector (8 see FIG. 2) protecting the image capture with further radiation management to transmit the image to the pixilated viewing screen (5) eliminating all damaging radiation to the welder's eyes (73 and 73a see FIG. 8).

A spherical lens barrel assembly (21) is located inside the insert (1) of the helmet (13). A lens barrel assembly (21) can have spherical or other geometric embodiments. The spherical lens barrel shape (21) lends itself for adjusting the viewing direction and enables automatic tracking the welding arc plasma (110 see FIG. 7a) to locate the welding plasma arc (110 see FIG. 7a) image to superimpose it on the pixilated viewing screen (5). The lens barrel assembly (21) contains; a half sphere (20), a flex circuit (18) conductor that is part of the pixilated image sensor (17), at least one short focal length imaging lens (19), and another half sphere (14) with the f-stops aperture (15), and pixilated image sensor mounting depression (16) to complete the spherical lens barrel assembly (21) to capture the ambient and the welding arc plasma video images with the pixilated image sensor (17). The least, one short focal length lens (19), enables without any focus adjustments high image resolution viewing of welding (see FIGS. 8, 8a, 8b and 8c). The flex circuit (18) conductor is connected to a printed circuit board (49 see FIG. 7) for image capture instruction, image editing, image processing, and image predicting of the captured images from the pixilated image sensor (17).

Many alternate embodiments forth lens barrel assemblies (21) to capturing and project the ambient, and all variety of welding plasma arc (110 see FIG. 7a) images on to a pixilated image sensor (17). Embodiments for the lens barrel assemblies (21) for ambient, and for different welding plasma arc (110) images are adjusted within the dynamic range of the pixilated image sensor (17). Employing a plurality of dedicated lens barrel assemblies (21) enables viewing a multitude of different welding techniques captures images for superposition and transmission onto the pixilated viewing screen (5).

During welding real time adjustment of overexposed and underexposed individual pixels which are part of the pixilated image sensor (17), are detected and individually corrected for such over, and under exposure to adjust pixels individually to extend the dynamic range of the pixilated image sensor (17).

The nanometer technology with extreme image resolution of a pixilated image sensor (17) combined with the extreme processing speed of ICs (integrated circuits) will enable welding images capture and editing, and image prediction with extreme dynamic range through one or more of the following: ASA (pixel amplification), shutter speed (pixel read speed), electronic processing, selectively on individual pixel, or chromatic adjustments to greatly improve real time viewing with a larger dynamic range of the image scene and provide a comprehensive welding image by bridging the energy ratio from ambient to the plasma arc (110 see FIG. 7a) brightness.

The image energy ratio in welding between the ambient and plasma welding arc (110 see FIG. 7a) illumination energy reaches a 1 to 1 billion ratio. Further at least one pixel of the pixilated image sensor (17) is dedicated through filtering for sensory needs, to analyze the electromagnetic welding spectrum and collect data. The pixilated image sensor (17) digitally partitioned will provide imaging positioning on the pixilated viewing screen (5) and analytical information such as welding plasma arc (110 see FIG. 7a) size, welding bubble dimension position, temperature, and geometry.

After an image is captured and transmitted to a pixilated viewing screen (5) with high pixel count, further image improvement is achieved by using such a pixilated viewing screen (5) for magnification optics, for detailed viewing of the welding arc plasma and image enlargement for exposure range reduction. Processing electronics for image enlargement and screen positioning or further chromatic filtering of viewing optics can increase the viewing comfort, welding image quality, and eye protection (see FIGS. 8, 8a, 8b, and 8c).

FIG. 4 shows a single spherical lens barrel assembly (21) that captures and projects the image onto the pixilated image sensor (17). Processing capturing the image with the pixilated image sensor (17) with ICs (50 and 51) (see FIG. 7) and transmission to the pixilated viewing screen (5) for viewing by the welder. Placing the spherical lens barrel (21) between the lid's (4) spherical impression (24) permits tilt rotation See FIG. 5). The spherical impression (24) is a feature of the protrusion (23) inside lid (4) and captures the spherical lens barrel (21) with freedom to tilt up and down and left and right to capture, size, and position the ambient and magnified welding plasma arc (110 see FIG. 7a) image for transmission. The inside protrusion (23) of lid (4) includes the aperture (22) enabling the optical transmission of images to be projected onto the pixilated image sensor (17).

The optical system in lens barrel assembly (21) with information from the image processing ICs (integrated circuits) (50 and 51 see FIG. 7) instructs capture settings for the welding and ambient images. Sensory data from the pixilated image sensor (17) or the sensor array (11) with real time imaging data adjusts the image capture of the pixilated image sensor (17) to compensate in real time for exposure variations. The captured welding arc plasma (110 see FIG. 7a) image information from the pixilated image sensor (17) is optically or/and digitally magnified to superimpose onto the ambient image or as a standalone welding plasma arc (110 see FIG. 7a) image.

By choosing individual pixel selection to control exposure of the welding plasma arc (110 see FIG. 7a) increasing the dynamic range of the pixilated image sensor (17). This technique will permit detailed viewing of the welding plasma arc (110 see FIG. 7a) images, producing a larger viewable image with high resolution, brightness, and contrast. The image that is viewable will not be limited by the rapid illumination difference of the welding arc plasma (110 see FIG. 7a) image due to the spherical spreading (4/3πr4). Image processing IC's (integrated circuits) (50 and 51 see FIG. 7) and a pixilated viewing screen (5) further will enable image improvements for the welder such as editing, filtering, displaying, magnifying, and image prediction.

Digital video image editing takes place after image capture by the pixilated image sensor (17). Editing demands high-quality video images within the dynamic range of the pixilated image sensor (17). Well-known techniques are available for editing and accommodating individual welder's image preferences.

The tools of editing are limited to subtracting, modifying images, improving sharpness, contrast, brightness, removing colors such as red, and modifying the hue of a color. Programmed Image capture is a tool for adjusting the images that are within the dynamic range of the pixilated image sensor (17) to improve viewability. Real time capture adjustments produce viewable and editable digital video images. Liquid crystal filters (9) and filters (9) assist in damping illumination during the welding plasma arc (110 see FIG. 7a) capture methods.

Electronic adjustment in real time of the image capture of pixilated image sensor (17) adjusts the images dynamic range for the pixilated image sensor (17). High-performance IC's (integrated circuits) select the pixel sensitivity (ASA) and read speed (shutter speed) to adjust the dynamic range of ambient and the welding arc plasma images so that a single barrel lens assembly (21) is providing ambient, and welding arc plasma (110 see FIG. 7a) quality images. Next to capture programming, f-stop aperture (15), filtering and editing means will also contribute to generate a quality image for the welder.

Considerable magnification is needed to show a detailed image of the welding plasma arc (110 see FIG. 7a) with the all-important puddle of molten metals for fusing. Magnification is important to increase the size of the small plasma arc (110 see FIG. 7a) image, for detailed viewing by the welder and diminishing the exposure range to be within the dynamic range for detailed viewing to evaluate welding.

Optically magnifying the extremely small welding arc plasma image (110 see FIG. 7a) to be viewable in detail requires optical adjustments from a wide-angle ambient image. Magnifying the welding plasma arc (110 see FIG. 7a) images in real time during exposure by controlling individual pixels and extend the image size of the welding arc plasma image (110 see FIG. 7a) and superimposing the image onto the ambient image increases the viewable dynamic range of the welding image. By increasing the dynamic range of welding image and superimposing the magnified welding plasma arc (110 see FIG. 7a) to be part of the ambient image viewable by a welder on the pixilated viewing screen (5) will be beneficial.

Electronically magnifying the pixilated image sensor (17) by extracting the small welding arc plasma (110 see FIG. 7a) image, and the small surrounding by the welding arc's plasma arc (110 see FIG. 7a) illumination to capture the dynamic range that can be adjusted to the dynamic range of the pixilated image sensor (17). The area that can be adjusted is small since the illumination fall out is an expanding spherical function. Electronically and/or optically expanding the welding plasma arc (110 see FIG. 7a) image for display on the pixilated image screen (5) will facilitate detailed viewing of the weld.

Electronically magnifying the pixels of a pixilated image sensor (17) to capture and expand the small welding plasma arc (110 see FIG. 7a) image with nano IC's (integrated circuits) technology should help improve the welding plasma arc images of the welding process. Nano size pixels permit large magnification of the small welding arc plasma (110 see FIG. 7a) sections of the captured image without image degradation. Digital magnification of the individual pixels that are illuminated by the plasma weld arc (110 see FIG. 7a) including the resolvable surrounding image, that is dynamically adjustable to the dynamic range of the pixilated image sensor (17), is chosen to fill part or the whole of the pixilated viewing screen (5). By superimposing over the wide-angle ambient image, a magnified plasma arc (110 see FIG. 7a) creates an extreme dynamic range image for display. Starting the welding arc plasma (110 see FIG. 7a) will activate digital magnifying. Options between preselected, or welder selectable magnification can be part of a mode selection with a setting selection option.

Mechanically inserting or adjusting magnifying optics to enlarge the small arc plasma image (110 see FIG. 7a), including the dynamic range of the surroundings that is within the dynamic range of the pixilated image sensor (17) is another viewing solution. The optically magnified image, expands and projects the welding plasma arc (110 see FIG. 7a) on to the pixilated image sensor (17), spreading the illumination by the magnification factor improving illumination and contrast control as function of the magnification. Optical magnification options include, for example, inserting a fixed magnification lens or lenses by sensing the start of the welding art plasma arc (110 see FIG. 7a); adjusting a zoom lens to select magnification by sensing the start of the welding plasma arc (110 see FIG. 7a) (the zooming mechanism will be part of a lens barrel assembly (21) as an alternative to electronic zooming (see FIG. 7)); electronic magnifying, compared to optical magnification; a small portion of the image on the pixilated image sensor (17) is electronically enlarged transmitted and displayed on to the pixilated viewing screen (5); magnification is software selectable; or the captured optically magnified images from the pixilated image sensor (17) are transmitted to the pixilated viewing screen (5) for viewing by the welder.

The welding plasma arc can be superimposed over the ambient image for presenting complete welding scene images.

Three short focal length single barrel (21) embodiments of short focal length projection optics with electronic processing control are;
a) actuators to bridge the exposure difference between ambient and welding plasma arc.
b) exposure biased projection optic controlled with electronic processing controlling amplification and read speed.
c) Electronic processing control for imaging and data gathering unobstructed from the 4 Kelvin welding plasma arc. Electronic processing enabling observation of the molten welding puddle.

The high energy plasma arc image can be turned off (110 see FIG. 7a) for viewing ambient and welding images.

A single lens barrel (21) with an electronically controlled video imaging system for ambient imaging and electronic magnification of the welding plasma arc image (110 see FIG. 7a) is turning off the welding arc plasma (110 see FIG. 7a) for short intermediate time periods to produce high quality welding images from the weld bubble luminosity that reduces the exposure energy between ambient and welding.

According to another example embodiment of the invention, the welding system includes processing electronics that turns off a plasma arc prior to imaging the welding scene. By turning off the welding arc plasma (110 see FIG. 7a) for a brief time, creates ambient illumination during welding and negates the high illumination ratio between ambient and the welding plasma arc (110 see FIG. 7a). Real time adjustment needs for exposure are greatly reduced without the bright illumination of the welding plasma arc (110 see FIG. 7a). Choosing a refresh frame rate independently from standard video frame rates will produce refresh dictated by welding progress. This will open capture of welding images independent from the limits of human eyesight. (See FIG. 8). Interlaced with electronic frames and electronic processing predicted frames with sensor data will produce a high-quality standard video of the welding in progress with the ambient image part of the welding scene.

A small-time fraction for the single frame allotment enables the pixilated image sensor (17) to grab an ambient image video frame of the weld image excluding the welding plasma arc (110 see FIG. 7a). The short, pulsed images are assembled and provide viewing welding videos without the welding arc plasma (110 see FIG. 7a). By eliminating the extreme illumination image energy of the welding plasma arc (110 see FIG. 7a) dynamic range of the pixilated image sensor (17) will be sufficient to cover the welding process including the molten weld bubble. Rapid sensor analysis of the weld bubble that contains the information needed to assess the welding process.

When there is a need for a new image to update the welding information and data, the welding arc plasma is turned off for a small-time fraction to capture a single image to update the welding video. Niño technology integrated circuit with high amplification (>1000000) and processing speeds will enable rapid image and data capture (<1 millisecond). Separating human viewing from electronics is of foremost importance to assess and adjust in real time the variables of a weld. This technique will eliminate recovery time from overexposure of the retina.

The pixilated image sensor (17) captures ambient video frames under ambient exposure conditions. By use of large pixel amplification (ASA) and a small f-number (large lens opening for low light conditions) exceedingly small frame time rates will require minimal time of welding plasma arc (110 see FIG. 7a) interruption. The electronic network turns the welding arc plasma off for a small fraction of time. During the welding arc plasma off time, the pixilated image sensor (17) captures an ambient image edits it and transmits the image with the weld bubble in clear view on the pixilated viewing screen (5) with the effect that a complete quality image of ambient and welding will be on display. The weld bubble will be accessible for sensor data collection and viewable to the welder.

Electronically magnifying the molten bubble over the wide-angle ambient picture on the pixilated viewing screen (5) by superimposing the magnified picture onto the pixilated imaging screen (5) at the weld seam location of a given welding assembly will present to the welder a comprehensive welding view to assist and improve the welder's craftsmanship.

It should be noted that standard frame rates used for video images can be filled with images from memory and image predictions to produce a standard high frame video with rapid image capture when needed. By using motion data of the easy to track welding plasma arc (110 see FIG. 7a) a quality video can be assembled with few image update requirements because the metal fusing will be sensor and predictable through calculation. With a single image captured in less than 1/1000 of a second a video stream of several seconds can be supported including the network with the necessary welding information. By adjusting the welding machine power output with the network, the power loss is compensated for the energy loss due to the power off time. In summary the ability to predict video images from single still images will offer numerous imaging advantages to welding.

In another example embodiments of the invention, the welding system includes processing electronics that pulsates the image provided by the image sensor to provide an improved image. For example, during thin wall welding the welding electrode is pulsated causing the welding material to crystallize before rapid melting eliminates the possibility of fusing. Pulsating in combination with the real time imaging of the present invention improves the thin material welding process.

With the IC (integrated circuits) imaging electronic all those welding techniques see FIG. 7a) are coordinated through the network with updates to manage and assist the welder. By adjustable pulsating, the welding arc plasma (110 see FIG. 7a), image gathering, welding, welding power supply setting, and continued quality assessments will complete the network (See FIG. 7). The network synchronizing all welding functions will advance welding.

Single lens barrel embodiments with actuators for viewing ambient and welding images follow. A single imaging system employing mechanical actuators shown in (FIGS. 5, and 5a) for inserting and removing filters (9), f-stops aperture (15), or pre-selectable f-stop apertures (15), optical magnification, selectable electronic magnifications, electro-mechanical tracking the welding arc plasma (110 see FIG. 7a) in real time provides a video of the welding arc plasma on the pixilated viewing screen (5 see FIG. 1) by bridging the image exposure between ambient and the welding plasma arc (110 see FIG. 7a).

Further, real time adjustment of the image captured with sensitivity (ASA) amplification and pixel read speed (shutter speed) with the pixilated image sensor (17) compensates for real time ambient and welding arc plasma (110 see FIG. 7a) exposure differences. This imaging embodiment will benefit from separating image gathering rates from the human requirement established of viewing standard video frame rate.

The spherical spread function exposure variation for the welding plasma arc (110 see FIG. 7a) demands real time capture adjustments to project a quality image onto the pixilated image sensor (17).

Matching the dynamic range of the pixilated image sensor (17) is accomplished by electromechanical actuators changing the image gathering from an ambient exposure setting to the welding plasma arc (110 see FIG. 7) exposure.

Biased lens barrel design without movable mechanical components for viewing ambient and welding images follows. A single lens barrel assembly (21) is biased (compromised) with filters (9 see FIGS. 2 and 2a) and f-stop aperture (15) for the ambient, and the welding arc plasma exposure. By correcting the bias electronically for the ambient, and for the welding plasma arc exposure the design of one lens barrel without mechanical actuators will be feasible enabled with high-speed nano integrated electronics offering extreme amplification rate for (ASA) (>1,000,000 times) and processing speed (image gathering time). By separating image gathering frame rate from the standard frame videos for human viewing (30 frames a second) the electronic image capture is greatly enhanced and by translating those images into standard video frame rate to presented to a welder will show those advantages.

The bias corrects electronically image capture of ambient and the welding plasma arc (110 see FIG. 7a) with the pixilated image sensors (17). The errors for ambient underexposure, and the welding arc plasma (110 see FIG. 7a) overexposure are corrected for underexposed ambient images by programming the pixilated image sensor's (17) capture increasing the pixel sensitivity (ASA), and slowing the pixel read speed (shutter speed.

Overexposure correction of the welding arc plasma (110 see FIG. 7a) video is accomplished by programming the pixilated image sensors (17) in the opposite direction by decreasing the pixel sensitivity (ASA) and by increasing the pixel read speed (shutter speed).

In summery sensing real time exposure with the pixilated image sensor (17) or a sensor from sensor array (11) then adjust in real-time for ambient illumination differences, is accomplished by increasing or decreasing the image capture sensitivity (ASA), and the pixel read speed (Shutter speed).

The spherical spread function of the welding arc plasma (110 see FIG. 7a) causes large illumination variations with small distance changes to the plasma arc (110 see FIG. 7a) effecting the dynamic range of the image and requiring real time adjustment of the captured image to adjust the exposure. Sensing, with the pixilated image sensor (17) or with another sensor from sensor array (11) real time adjusting capture for the welding plasma arc (110 see FIG. 7a) illumination is accomplished by increases or decreases the sensitivity (ASA), and the pixel read speed (Shutter speed) to alter the projected dynamic range of the image to match the dynamic range of the pixilated image sensor (17) to be edited and processed for the welding plasma arc (110 see FIG. 7a) images to be transmitted to the pixilated viewing screen (5).

Exposure biasing for the extremely large exposure energy difference between ambient and the welding arc plasma (110 see FIG. 7a) is enabled using high to low rates of amplification and the high to low image gathering speed adjustments.

By separating electronic image gathering from the standard video frame rate utilizing the processing speeds of the nano IC (integrated circuit) technology will increase image gathering latitude with added flexibility, such as capturing images in favorable condition.

Image gathering speed locked to human eyesight and with standard video frame rates during ambient the underexposed image capture by the pixilated image sensor (17), is limited by the frame rate (shutter speed) that determines a finite maximum time limit. A standard video frame rate (30 frames/sec) determines the maximum available pixel read speed (shutter speed) time of 1/30th sec. A slower pixel read time (shutter speed) available for the pixilated image sensor (17) is determined by the human eyes lag time of about 0.200 sec to follow motion. That allows a video frame rate of >5 frames/sec. to be beyond the human perception of flicker.

Presenting a flicker free video to the welder, by choosing >5 pictures/sec determines the maximum time available to read a pixel (shutter time) and it is <0.200 sec. Adhering to, the 30 frame/sec a standard video frame results in a read speed (shutter speed) 0.033 seconds. The large rate of amplification coupled to the available (shutter speed) will determine the maximum bias for an underexposed correction. Separating video capture from those limits enhances the imaging to bridge the exposure demands from ambient to the welding plasma arc (110 see FIG. 7a) images.

The overexposure of the illumination energy of the welding plasma arc (110 see FIG. 7a) is compensated for with the processing speed of the nano IC's (integrated circuit) coupled with low amplified sensitivity (ASA) selection when separating the image gathering from the demands of video frames or the human eyesight. This separation should enhance imaging of the welding plasma arc. (110 see FIG. 7a) and diminish processing requirements.

Electronically managing image capture, with the pixilated image the sensor (17) will lessen the needs for filter (9 see FIGS. 2 and 2a)) and f-stop aperture (15). Biased compromise settings of image gathering produces biased dynamic exposure ranges that can be processed to capture a quality ambient, and welding arc plasma (110 see FIG. 7a) video on the pixilated image sensor (17) to be transmitted for viewing on the pixilated viewing screen (5 see FIG. 1) will enable to show ambient and the welding plasma image simultaneously by employing those imaging methods. Electronic magnification of the welding plasma arc (110 see FIG. 7a) is needed to show the small image for detailed observation of the welding process.

Techniques description for pulsation of the welding plasma arc (110 see FIG. 7a) can also be employed for biased lens barrel assembly embodiments. Predictive imaging is a technique that will provide images of the highest quality and utility with few images.

An embodiment of extreme dynamic range imaging for viewing ambient and welding images follows. Extreme dynamic range imaging shows the welding arc plasma (110 see FIG. 7a) and the ambient image simultaneously by superimposing the magnified welding image onto the ambient wide-angle image. Capturing different dynamic rate video images is enabled with adjusted dynamic ranges to bridge the exposure gap between ambient and the welding plasma arc (110 see FIG. 7a) for at least two pixilated imagers (17). By assembling the two pictures superimposing the magnified welding plasma arc (110 see FIG. 7a) into a single image to transmit to the pixilated viewing screen (5) will show a video with an extreme dynamic range.

An optically or digital magnified welding arc plasma image can be superimposed into the video image for close surveillance of the welding arc plasma. At least two pixilated image sensors (17) capture with a prism two single frames and electronically superimposing accomplishes the extreme dynamic range image.

Embodiments of video viewing of laser and other welding techniques without the current driven welding plasma arc follow. The invention is adaptable to other welding technologies such as Laser, gas, and super-heated gas plasma to protect the welder's eye and face from radiation and splatter and provide electronic managed or predicted images. A laser's high intensity illumination with a narrow energy bandwidth has a similar option to modulate the image capture with a pixilated image sensor (17) for viewing on the pixilated viewing screen (5). Narrow bandwidth filtering such as special masking of the pixilated image sensor (17), spectrum filter (9), including utilizing sensor data to adjust in real time image capture with the pixilated image sensor (17).

Laser welding is readily adoptable to electronic video observation and superimposing magnified welding images onto the ambient images.

FIG. 5 is an isometric drawing of the helmet (13) along the imaging centerline (12.) FIG. 5 includes the transparent disposable protector (8) and a filter (9). The protrusion (10) has a cylindrical opening, (25) to conveniently mount the filter (9) and the transparent disposable protector (8) for ease of insertion and exchange, and the aperture (22) opening for image transparency. It is understood that the filter (9) is a single filter (9) or combination of a gray scale, a chromatic, a crystal liquid filter (9) assembly. The liquid crystal filter embodies variable density adjustability (see FIG. 2a). Pixelated liquid crystal filter (9 see FIG. 2b) increase adjustability.

FIG. 5 shows an embodiment with controlling devices responsive to processing electronics for automatically adjusting welding setup and real time welding operation. The embodiment, wherein the electronic processing includes means for assisting the welder's limitation of sight and motion by analyzing welding position and speed and instructing the welder for weld speed and motion geometry.

The protrusion (10) is fastened to the outside of lid (4) and inside (see FIG. 4) the lid (4) is another protrusion (23). The protrusion (23) has a spherical cup (24) as shown in (FIG. 4). The front of the spherical lens barrel assembly (21) is inserted into the spherical cup (24). The lid (4) has an aperture (22) to permit the image information to pass through the lid (4) and is large enough to accommodate the f-stop aperture motion of the lens barrel assembly (21). The opening size of the f-stop's aperture (15) is further adding dynamic range adjustment of the projected image onto the pixelated image sensor (17). The f-stops aperture (15) location will be a part of the imaging optics and not necessarily in the front of the lens barrel assembly (21). A small f-stop number (large diameter) aperture (15) is used in low light, and large f-stops numbers (small diameter) is for high illumination scenes. The image plane error from infinity to the welding arc plasma position is minimal with a small focus length lens (19). To maintain image sharpness (see FIG. 9) the focus, for the short focal length lens (19), is optimized for the welding arc plasma distance shifting the image plan position error to large and infinity distances. (The pixelated image sensor's (17) front surface is the image plane).

The lens barrel assembly (21) is located by the spherical depression (22) (see FIG. 4) and is part of the lid's (4) inside protrusion (23 see FIG. 4) to enable horizontal and vertical tilting with actuators (30) and rear lens cylinder hole (34) capturing drive pin (33.) Actuators (30) locate magnified images onto the pixelated viewing screen (5). The pixelated image sensor (17) shown in (FIG. 4) produces servo information for electronic processing of weld tracking. Images are tracked by partitioning the pixelated image sensor (17). The flex circuit (18) of the pixelated image sensor (17) connects to the printed circuit board (49) for real time image capture instructions and is part of the network that also includes image processing, image storage, editing, image transmission to the pixelated viewing screen (5), data display, radiation management and information exchange for real time (during welding) welding power supply, electrode, arc plasma settings and weld monitoring.

A cylindrical flat wave spring (35) can be used to sandwich a horizontal (X direction) plate (31), a (Y direction) translation plate (32), and the lens barrel assembly (21) between lid (4) and box (3).

Inside the box (3), the spring (35) traps plate (31) and (32). The tilting of the spherical lens barrel (21) is accomplished by the two movable plates, (31) moves in X direction and plate (32) in the Y direction. The plate's motion is transferred to the spherical lens barrel assembly (21) by friction or as shown in this embodiment by a spherical drive pin (33) and a cylindrical drive hole (34). Two actuator (30) mechanism transfer the linear motion to two-drive plates (31) and (32) one for the horizontal X direction and the other in the vertical Y direction, tilting the spherical lens barrel (21) tracks the welding arc plasma (110 see FIG. 7a) or any other scene and projects the image at the desired location on the pixelated image sensor (17) for transmission to the pixelated viewing screen (5). Also shown is an X direction actuator assembly (30) for plate (31) and a Y actuator assembly (30) for plate (32). The actuator assemblies (30) have an actuator drive link (26) a gearbox (27), a drive motor (28) and a threaded shaft (29) to drive the plate (31 and (32). through the drive hole (26a). Tracking information is provided by the pixelated image sensor (17) digitally partitioned to extract the tracking information. This arrangement will improve viewing by centering magnified and selectable images on the pixelated viewing screen (5). Many embodiment implementation for tracking the plasma arc are executable to the one trained in this art.

The programmable pixelated image sensor (17) is attached to a flexible conductor (18) that transmits the optical image captured to the printed circuit board (49). The printed circuit board (49) contains at least one image processor IC (integrated circuit). The image processor (50 and 51) in this embodiment program the image capture to be adjusted within the dynamic range of the pixelated image sensor (17). Image capture and other means such as filters (9) and the f-stop aperture bridge the huge energy gap between the ambient and the welding arc plasma image (110 see FIG. 7a). The image processor (50 and 51) also manages the arc free welding monitoring, imaging, picture storage, editing, and image transmission to the pixelated viewing screen (5) (see FIG. 1). The embodiment shown has two image processing ICs (integrated circuits) (50 and 51) to be discussed shortly (see FIG. 7).

The printed circuit board (49) is shown as an assembled part of helmet (13). It will be understood that the printed circuit board (49), the image processor ICs (integrated circuits) (50 and 51), actuators and all other parts of the helmet's (13) imaging system can be part of a single insert (1), in a helmet (13) or be mounted or positioned with separate boxes conveniently located inside or outside the helmet (13). More than one helmet (13,) or insert (1) designs can be manufactured in embodiments of this invention.

The circuit board (49) equipped with an actuator drive IC (integrated circuit) (52) for actuators (30 and 30a) tracks the welding arc plasma (110 see FIG. 7a) image and position the magnified welding arc plasma (110 see FIG. 7a) image on the pixelated image sensor (17) to be transmitted to the pixelated viewing screen (5) for optimum viewing and positioning. The positioning information is extracted by partitioning the pixelated image sensor (17) for the instructions to drive and position the actuators (30 and 30a) which control the drive plates (31 and 32). The dynamic range for the pixelated image sensor (17) determines filters (9) density and color, f-stops aperture (15) size, and image capture programing for sensitivity and capture velocity. (Explanations see FIG. 4)

FIG. 5a is an isomeric drawing of a different embodiment of the insert (1) with the lid (4) and an additional protrusion (36) that contains a filter aperture selection wheel (37). With a multitude of selectable filters (9) or f-stop apertures (15). The protrusion (10) with the disposable transparent protector (8) with aperture (22) is part of protrusion (36). On a shaft (39) part of protrusion (36) rotates a filter aperture selection wheel (37). An actuator (38) with a gearbox (41) and a pinion gear (42) drives and positions a filter f-stop aperture wheel (37) to be centered on the optical center line (12). A filter (9) or a f-stop aperture (15) or a combination of both can be selected to permit viewing of all the different welding techniques.

FIG. 5b is an isomeric drawing of a cross section through insert (1) to present a more detailed embodiment of (FIG. 5a). The protrusion (36) contains the filter f-stop aperture selection wheel (37) and positions by the proper filter (9) and or f-stop aperture (15) or a combination of both by rotation with a motor actuator assembly (38) that consists of a motor, (40) a gear box (41), and a pinion gear (42). The filter f-stop aperture wheel between (37) is trapped inside protrusion (36) and lid (4). The filter (9) f-stop aperture (15) selection wheel (37) rotates around the pivot shaft (39) part of the protrusion (36). Protrusion (10) in this embodiment is part of protrusion (36) and is part of insert (1). The apertures (22) pass the image through protrusion (10), and protrusion (36), the lid (4), so that the image can by projected to the pixilated image sensor (17) that is part of the spherical lens barrel assembly (21. The cylindrical assembly cavity (25) for the disposable transparent protector (8) is part of protrusion (10). The lid (4) of insert (1) with an inside protrusion (23) with a spherical cup (24) locates the spherical lens barrel (21). The spherical lens barrel (21) with the cylindrical tilt drive hole (34), the pixilated image sensor (17) and the at least one imaging lens (19) is shown for clarity.

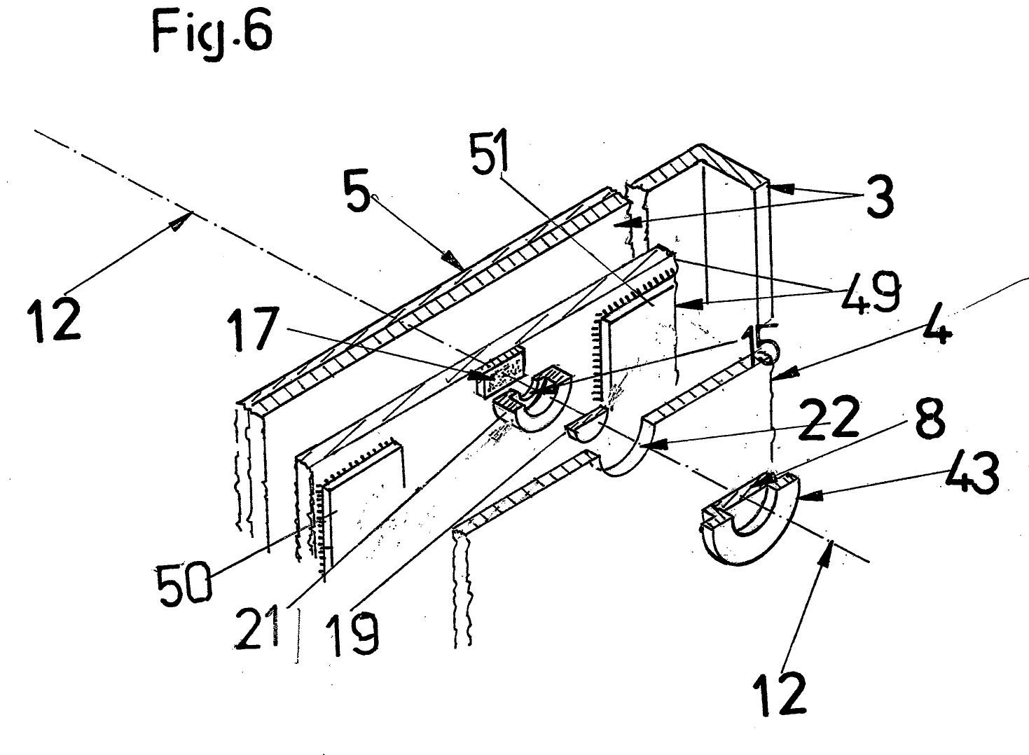

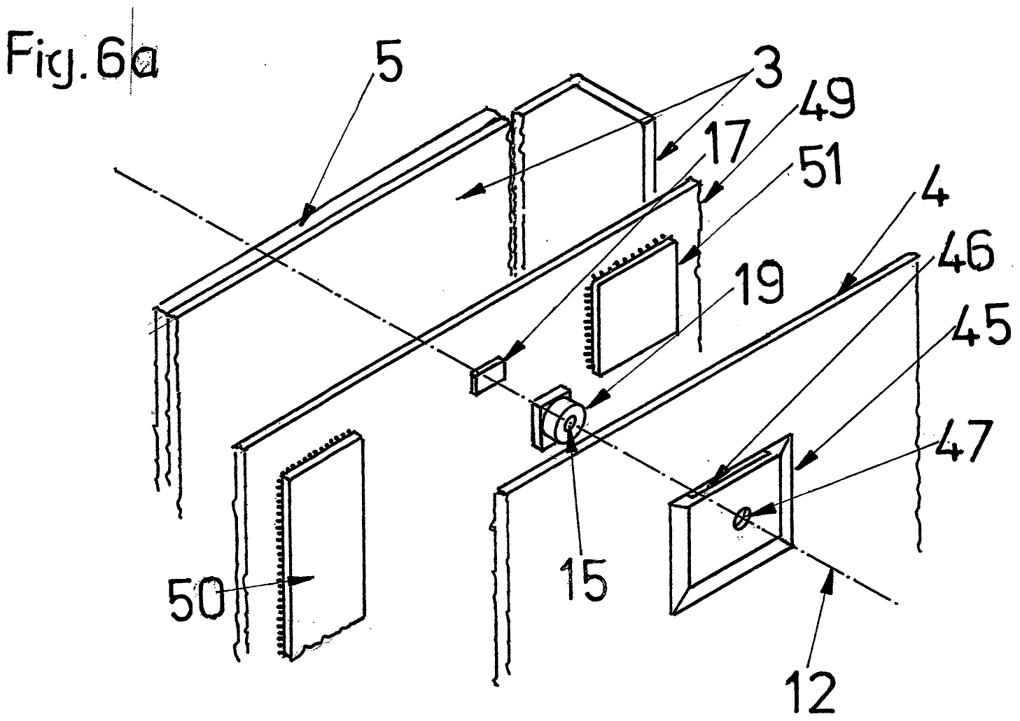

FIG. 6 is an isomeric drawing of a simple embodiment without mechanical image tracking (see FIG. 5). High pixels count of the pixilated image sensors (17) will enable electronic tracking. The centerline (12) between the welding scene and the welder's eyes (73 and 73a) with a stationary lens barrel (19) containing imaging lens (19) is part of the printed circuit board (49 also see FIG. 7) with the pixilated image sensor (17). The disposable transparent protector (8) made from transparent matter to be easily replaced after weld splutter damages is part of a convenient assembly of the disposable transparent protector holder (43). The disposable transparent protector (8) is part of the holder (43) that protects the filters (9), imaging lens (19), and the printed circuit board (49) from weld splutter and radiation.

The welder's eyes (73 and 73a) are completely protected with hardware such as the pixilated viewing screen (5) that displays safe managed radiation, the insert (1), the lens barrel assembly (21), the disposable transparent protector (8) assembled and lid (4).

A cylindrical lens barrel (21) including the f-stops aperture (15), with at least one focusing lens (19) and is part of the printed circuit board (49) of insert (1).

The pixilated image sensor (17) is shown as part of the printed circuit board (49). Lens (19) focuses images on to the pixilated image sensor (17) by mounting the lens barrel assembly (21) with the pixilated image sensor (17) at the, for welding biased, focal distance of lens (19). Shown for clarity two processing integrated circuits (50 and 51) for multiple imaging systems are part of printed circuit board (49).

FIG. 6 shows the box (3) as part of the insert (1) and the pixilated viewing screen (5) attached to the rear of the box. All the functions of image preparations discussed in (FIGS. 4 and 5) are applicable to the lens barrel assembly discussed in (FIGS. 6 and 6a).

FIG. 6a is an isomeric drawing of an alternate simplified implementation for a stationary system. This embodiment shows three parts, the lid (4), the printed circuit board (49), and the box (3).

The front towards the weld has a small square protrusion (45) for simple exchange of a small square disposable transparent protector (46) with and frontal aperture (47) to collect the image information with lens (19 see FIG. 6) to project on the pixilated image sensor (17). The printed circuit board (49) contains integrated circuits (50) and (51) providing all the electronic functions for image capture, editing and transmission (see FIGS. 4, 5, and 7.) A cylindrical lens barrel (19) with a f-stop aperture (15) can penetrate the lid (4) as part of the printed circuit board (45). The circuit board (49) is assembled in this embodiment inside the insert (1) with the pixilated viewing screen (5) attached to the back of the box (3).

FIG. 7 describes the electronic diagram to connect welding systems in a network that is connected to a communal data center will greatly profit from the accumulated data and the artificial intelligence for managing welding parameters. The network power including a welder is powered with two switches and recording. The network (see FIG. 7a) transmits data, and processed data information that is viewable or audible to instruct the welder to adjust in real time welding such as plasma arc speed and direction. Network corrections are done electronically within the network to achieve high quality welding such as plasma arc (110 see FIG. 7a) control motion adjustment arc pulsation and material feed.

Driver (65) interfaces the sensor array (11) as part of the network (see FIG. 7a) to inform the welder, or automatically adjust the welding power supply (48) material feed, welding plasma arc (110—see FIG. 7b). The network is also set up for real-time correction. All the drivers can be combined into one IC (integrated circuit) or be part of the Processing ICs (50 and 51).

According to another example embodiment of the invention, the welding system includes a controlled device responsive to the processing electronics for adjusting a weld provided in the welding scene image. The controlled device can include, for example, a welding device controlled by a welder or an automation system, such a robotic welding system, for adjusting the weld. When the welding system includes a controlled device, some example embodiments of the invention include processing electronics having means for capturing image frame information including frame rate information that is used to determine when adjustment of the weld occurs. In other example embodiments, the processing electronics has means for turning off a plasma arc prior to imaging the welding scene producing an improved welding scene image that is substantially free of the plasma arc.

In other example embodiments, described in more detail herein, the processing electronics associated with the image sensor includes artificial intelligence, for example, an AI chip included with the processing electronics or connected via a network, for analyzing the welding scene in real time and providing information related to the welding scene. The processing electronics can control the controlled device to adjust the weld based on the analysis of the welding scene. Network examples include, but are not limited to, wired, wireless, LAN, or cloud based.

A c-moss or CCD pixilated image sensor (17) with a flexible conductor (18) is connected to circuit board (49). The sensor array (11 see FIG. 3) and foremost the pixilated image sensors (17) content of precise pixel pattern enable defining the geometry of a welding assembly to pre-calculate the optimum welding practice for instructing and network automation. This information, including the welding material selection, will enable calculation of welding needs in real time for a given welding assembly. Pixilated image sensors (17) are extremely sensitive to monitoring the infrared spectrum in real time and will contribute to welding quality by continuously adjusting the network to the information changes gathered during welding. The pixilated image sensor (17) can utilize specific sensing for automation and robotic welding such as timing sequences or radiation sensitivity. Automation is not limited by the physicality of human sight and relies on ever-improving sensor technology.

As shown, IC (integrated circuit) (55) is at least one microprocessor that acts as the controller to manage the helmets (13) functions such as viewing, monitoring, instructing, and adjusts welding operations. Also as shown, IC (integrated circuit) (59) communicates wireless network information for sensor reception and instruction transmitted with antenna (59a) to the network (see FIG. 7a) including communication with a communal data center (122 see FIG. 7a) and artificial intelligence to open a new age in welding.

The helmet (13) does not necessarily contain all those function within the network some functions can be omitted or located elsewhere in the network in automation the helmets' purpose will be limited to observation, setup, and maintenance use. The pixilated image sensor (17) captures the image and welding information data and transmits the data to IC (integrated circuits) (50 or 51) for processing. The image information is interpreted in real time to adjust image capture, to compensate for ambient and welding arc plasma illumination variations. The processing ICs (integrated circuits) (50 and 51) will manage digital and optical magnification, image storage, digital chromatic filtering, image presentation to be transmitted to the pixilated viewing screen (5) and manages welding information within the network (see FIG. 7a) to advise the welder and adjust the network for optimal performance. The processing ICs (integrated circuits) (50 and 51) can use color filter portions of the pixilated image (17) and general sensor (9) for filtering. For scene balancing a Bayer pattern commonly used has red, blue, and green pixels to adjust them for a viewer. The human eye is more responsive to green therefore the Bayer pattern is using more green pixels. By using the Bayer pattern, pixel correction, defective pixel correction Isa well know technique to fix defects on the pixilated image sensor (17), and further editing of the images to chromatically balance and sharpen the image to be transmitted to the pixilated viewing screen (5). Image processing technology is available in open sources. In automation or AI (Artificial intelligence) processing the pixilated image sensor (17) is altered to the automation and AI (Artificial intelligence) requirement.

Heretofore, a welder could not use digital image processing and network interfacing in real time. This inventive structure not only protects the welder's eye but also the electronics needed for digital image processing. The present inventions permit optical and digital image processing to be used by the welder. Programmable image capture, image processing, color filter image processing, three dimensional, and network automation and AI (Artificial intelligence) image processing are now available in the welding network.

The image processing ICs (integrated circuits (50 and 51) uses information from the pixilated image sensor (17) or alternate array sensor (11) data, such as illumination, current, temperature, gap resistance or capacitance, and arc geometry (see FIG. 3). to interface and communicate with the welding network such as power apparatus (48), the welding methods in use such as TIG welding, and including informing for the welder by transmitting the information verbally or/and visually to the pixilated viewing screen (5).

UBS (60a) and a mini-C (60) connector ports provide access for programming, data retrieving, and battery (60) charging. A radiation collector a removable memory SD (scan disk) slot (60b) is also part of the electronics. An ambient and welding plasma arc (110 see FIG. 7a) radiation energy collector 61 is collecting the energy from the environment to operate the welding helmet (13). Connecting the welding helmet (13) with wires is possible but inconvenient. Recording the welding process and sensor data for quality will eliminate secondary quality checks to verify weld quality in real time. Network and electronics parts are not required to be contained on a single printed circuit board (49) or must be part of an insert (1) or helmet (13), but they can be located inside, outside, or separate to communicate with and power the welding network.

FIG. 7a is an isomeric drawing of commonly used welding methods. The network is enabled and controlled by sensors from the sensor array (11 see FIG. 3) and the pixilated image sensor (17 see FIG. 4). The welding network with a welder includes, a viewing helmet (13), the welding power supply (48), and a welding methods such as (106, 107, 108 and (109 laser welding)) Each of those well-known welding methods will greatly benefit from gathering real time images and sensor information to operate a connected welding network, that calculates then instructs and adjust the network settings. Manual setting and adjustments are suggested to a welder to guide him with verbal or visual means. Settings and real time adjustments, of the welding plasma arc (110) gap size (see FIG. 7b), arc power supply (48), and welding plasma arc motion in time and space for the different welding methods (106, 107, 108, and (109 laser welding) see (FIG. 7b) Electrode gap adjustments to assist a welder or automate gap accuracy to enable quality, high production rate and additive and subtractive welding.

Any one of those networks can be connected to a communal data center (122). The antenna (59a) shown on helmet (13) will provide communications with the communal data center (122). The collected welding information over time analyzed by AI will provide improving data to be utilized for improving welding quality, and productions.

Stick (106) welding uses the welding of a coated metal welding rod as electrode to form the welding plasma arc (110). Vaporizing the coating protects the molten metal from rabbit oxidation during the fuse of metals.

In MIG (108) a welding wire electrode is fed with a speed adjustable capstan drive to supply the correct material quantity and conducts the power for the welding plasma arc (110). In stick welding (106) a wire coating or an inert gas will protect the molten metal from oxidation. In a network this adjustable capstan (material feed speed) lends itself in real time to adjust material quantity and plasma arc (110) control.

In TIG (107) welding a separate tungsten tip provides the plasma arc (110) electrode including an inert gas as the welding material is added independently to melt and fuse the material protected by the inert gas.

In laser welding (109) high intensity laser light provides the melting energy (111) requiring that the welding material must be added independently to melt and fuse the welding material. The laser welding method is like the TIG (107) welding method as adding material is supplied into the photon plasma.

Many different embodiments to automated material feed lend itself in real time to adjust material quantity and plasma arc (110) for Stick (106) and Laser (109) welding.

In the ambient environment the pixilated image sensor (17 see FIG. 4) combined with the sensors in sensor array (11 see FIG. 3) analyzing the geometry of the weld and determine the power setting of the welding power supply (48) and the correct electrode distance for the welding plasma arc (110 see FIG. 7a) (110). During welding the pixilated mage sensor (17 see FIG. 4) with sensors from the sensor array (11 see FIG. 3) also provides real time instruction to the welder with information needed to avoid meltdown and cold welding. This information for setting and adjusting the welding parameters through the network is automated in real time.

In example embodiments of the invention, the welding system includes means for data collection, wherein the data collection means determines whether adjustments to a weld are needed. In some example embodiments, the processing electronics includes means for real time compensation of welding inconsistencies. For example, a gap between a device producing the weld and the weld material is controlled by sensor data and the processing electronics. The processing electronics can track a welding seam and the weld gap and update an ambient image. The processing electronics includes means for adjusting power provided by a power supply.

Visual welding instructions are displayed on the pixilated viewing screen (5) to a welder displaying in real time welding direction, speed, and plasma arc (110) electrode distance by interpreting the available sensor information. Continuously adjusting the power supply (48) for optimum welder plasma arc (110) and laser light (111) in real time, results in optimum material fusing. The welder is instructed in real time for welding direction and speed by verbal or visual means on the pixilated viewing screen (5) for a welder to adjusted electrode speed to optimize welding fusion.

This real time welding assessment and parameters adjustment through sensing helps to maintain welding quality. Image sensor data can be readily stored and available for use. Welding involves a human with a welding apparatus that provides the electric power to generate the welding plasma arc (110 see FIGS. 7a and 7b) to add and melt metal to fuse separate metallic parts together. Controlling this welding plasma arc (110 see FIG. 7a) gap (114) and moving it along the welding seam determines the quality of the welding structure. Maintaining the welding plasma arc (110) gap distance (114) affects welding quality exponentially (4/3πr\hat{ }3) and requires accurate gap (114) dimension control. Controlling the motion pattern in space and time, variation along a welding seam ( [symbol] t) is affecting welding linearly. The large temperature differences from metal melting to evaporation does tolerate considerable welding plasma arc (110) motion variation with less effect on welding quality than welding plasma arc (110) gap (114) dimension changes.

Means for controlling the exponential effect of the welding plasma arc (110) gap (114) dimension variation benefits from sensor information to electronically control the gap (114) dimension. Means of providing welding seam tracking information by sensor interpreted and calculated information for moving the welding plasma arc (110) speed in the X and Y direction (see FIG. 7b), to assist welders to achieve consistent quality and uniformity. Means to verbally or display the instruction for the welder to track a welding seam on the pixilated viewing screen (5 see FIG. 1). Means for controlling the motion by assisting the welder to accurately follow the weld seam by assisting human limits in position and speed accuracy with X and Y direction control through sensor and electronically controlled actuators. The isomeric drawing in FIG. 7 b shows an embodiment of electronics controlling the welding plasma arc (110) gap dimension (114) for the welding methods (106, 108, 110 and 109 see FIG. 7a).

An embodiment of the method (106 see FIG. 7a) uses a welding stick (115) that is a coated (115 b) metal stick (115 a). The welding plasma arc (110) will vaporize the coating (115a) to protect the molten metal from oxidation. One end of the welding stick (115) is left without the coating (115c) to enable low resistance power transmission from the welding power supply (48 see FIG. 7). The welding method (106 see FIG. 7a) is commonly known as stick welding. The metal stick (115a) provides the welding material needed for a given welding assembly. The other utilization of the metal stick (115 a) transmits power and functions as electrode to generate the welding plasma arc (110). The uncoated end (115c) of welding rod (stick) is connected to the power supply (48 see FIG. 7) with power cable conductor (121). The bare material of the welding rod (115) is captured by a capstan drive to control the gap dimension (114) and keep it constant. In this embodiment the welding gap (114) will be maintained in real time with the capstan motor drive consisting of a gearbox (117), motor (118), and encoder (119) inside the welding handle 120 operated by the welder. The welding plasma arc (110) power is managed with sensory data to generate an optimum welding bubble to fuse materials. C Monitoring the welding plasma arc (110) and real time adjusting the gap (114) with capstan drive (122) and the welding power with welding power supply (48 see FIGS. 7 and 7a) controls welding. Adding real time X and Y motion instruction (speed and position) along the geometry of the weld with sensor data and continuous power supply (48) control will improve welding sufficiently and enable subtractive and additive fusing for more detailed welding features.

The MIG (Metal inert gas) welding method (108 see FIG. 7a) utilizes a metal wire to supply the welding material and as the electrode to generate the welding plasma arc (110 see FIG. 7a). The wire is advanced with a speed adjustable capstan drive. Adjusting the capstan drive in real time and power supply in real time (48 see FIG. 7) can be selected to maintain the welding plasma arc gap (114) and power supplied to the welding material (108 see FIG. 7a). Power on and off pulsation is employable for imaging and welding control improvements.

The TIG (Tungsten inert gas) welding method (107 FIG. 7a) utilizes a tungsten rod electrode. Tungsten has an extreme high melting point 3500 degree Celsius a temperature that is much higher than material commonly used in welding the tungsten electrode requires welding material needed to fill the seams to be applies separately. An embodiment of the capstan control of the tungsten electron including, including weld motion instructions with sensor controlling the welding power supply (48) with real time power and on off pulsation for imaging, sensor function, and welding improvements.

The Laser welding method (111) utilizes high density photon to replace the welding plasma arc (110). The laser is focused and absorbed to generate the energy to melt metals. The gap (121) between the exit lens and the welding material is controlled by a welder and assisted with a mechanical spacer that is slit along the welding seem. The mechanical gap (121) is restrictive. Real time auto focusing the small gap dimension (f2=xx′) will compensate for the exponential energy variation (4/3πr\hat{ }3). Laser pulsation is employed to control and adapt laser welding to bridge human limitation in real time for achieving optimum welding. Real time instruction to assist the welder with motion directions for adaptation to welding geometry and speed will partner AI, robotics, and automation with the welder. A further advantage of gap control (114) is switching power on at the proper gap distance (114).

FIG. 7b the isomeric drawing in FIG. 7 b shows, the gap between a welding electrode and the welding material controlled by sensor data and the processing electronics.

FIG. 7 is an embodiment of process electronics controlling the welding plasma arc (110) gap dimension (114) for the welding methods (106, 108, 110 and 109 see FIG. 7a).

Method (106 see FIG. 7a) uses a welding stick (115) that is a coated (115 b) metal stick (115 a). The welding plasma arc (110) will vaporizes the coating (115a) to protect the molten metal from oxidation. One end of the welding stick (115) without the coating (115c) enables low resistance power transmission from the welding power supply (48 see FIG. 7). The welding method (106 see FIG. 7a) is commonly known as stick welding. The metal stick (115a) provides the welding material needed for a given welding assembly. The other utilization of the metal stick (115 a) transmits power and functions as electrode to generate the welding plasma arc (110). The uncoated end (115c) of welding rod (stick) is connected to the power supply (48 see FIG. 7) with power cable conductor (121). The bare material of the welding rod (115) is captured by a capstan drive that controls the gap dimension (114) to keep the weld puddle constant (temperature and size). In this embodiment the welding gap (114) will be maintained in real time with the capstan motor drive consisting of a gearbox (117), motor (118), and encoder (119) inside the welding handle (120) operated by the welder. The welding plasma arc (110) power is managed with sensory data to generate an optimum welding bubble to fuse materials. Monitoring the welding plasma arc (110) and real time adjusting the gap (114) with capstan drive (122) and the welding power with welding power supply (48 see FIGS. 7 and 7a) controls welding. Adding real time X and Y motion instruction (speed and position) along the geometry of the weld with sensor data and continuous power supply (48) control will improve welding sufficiently and enable subtractive and additive fusing for more detailed welding features.

The Mig (Metal inert gas) welding method (108 see FIG. 7a) utilizes a metal wire to supply the welding material and as the electrode to provide the power for generating the welding plasma arc (110 see FIG. 7a). The wire is advanced with a speed adjustable capstan drive. The embodiment of a real time adjustable capstan drive and power supply (48 see FIG. 7) to manage the welding plasma arc gap (114). and power for this welding method (108 see FIG. 7a). Power on and off pulsation is employable for imaging and additional welding puddle control.

The Tig (Tungsten inert gas) welding method (107 FIG. 7a) utilizes a tungsten rod electrode. Tungsten has an extreme high melting point of 3500 degree Celsius, a temperature that is much higher than material commonly used in welding. The tungsten electrode requires welding material needed to fill the seams to be applies separately. An embodiment uses the capstan control for the tungsten electrode, and includes weld motion instructions, for a welder, with sensor data and automatic power controlling the welding power supply (48). Further on off welding plasma arc (110 See FIG. 7b) pulsation for imaging, sensor function, and will also improve welding.

The Laser welding method (111) utilizes a high-density focused photon beam (laser) to replace the welding plasma arc (110). The focused laser is absorbed to generate the energy to melt metals to form a welding puddle that fuses separate parts with a weld. The gap (121) between the exit lens focus and the welding material is controlled by a welder and assisted with a mechanical spacer that is slit along the welding seem. Mechanical controlling the focus gap (121) restricts real time adjustments. Autofocusing the small gap dimension (f2=xx′) to compensate for the exponential energy variation (4/3πr\hat{ }3) adds real time control over the weld puddle compensating for motion speed fluctuations and enables directional motion. Employing laser pulsation to control and adapt laser welding to bridge human limitation in real time for optimum welding power control including real time instruction to assist the welder with motion directions and speed to produce an optimal metal weld puddle for fusing.

Summary; A further advantage of gap control (114) for all the welding methods (106, 108, 109, and 110 see FIG. 7a) is switching power on at the proper gap distance (114) by sensing the gap distance. Automation with nano IC (integrated circuit) large memory connected to the cloud enables building a statistical welding platforms for intelligent decision making for welding.

Referring to FIG. 8, the pixilated viewing screen (5) part of the network (see FIG. 7a) can be an LCD liquid crystal display. LCD stands for Liquid Crystal Display. Tiny red, green, and blue dots on the display are made visible or invisible by means of a voltage potential, which is perceived by the viewer as an image or video. However, an LCD screen itself does not produce light. This is only possible by means of light-emitting diodes (so-called LEDs). Therefore, one can look at LCD technology as the basis for flat panel displays.

The pixilated viewing screen (5) of the network (see FIG. 7a) can be an LED (Light emitting diodes) display. LED televisions are exposed by means of light-emitting diodes. These Light Emitting Diodes are called LEDs. In LCD televisions, such LEDs are used as backlights. On the screen, millions of tiny liquid crystals are opening and closing, sometimes letting the light from the LEDs through, partially through, or not.

The pixilated viewing screen (5) of the network (see FIG. 7a) can be a QLED a further development of a (Liquid crystal displays). QLED can be understood as a further development of LEDs and was first launched by Samsung in 2017. With this technology, the LED backlight passes through a special type of film made of nanoparticles, also known as quantum dots, on its way to the liquid crystals. These dots all react individually to the incident light and emit pure red, green, or blue lights and not just white light. This leads to more intense colors and contrasts and a greater variety of colors and hues.

The pixilated viewing screen (5) of the network (see FIG. 7a) can be an OLED (Organic Light emitting Diodes) display. Unlike LCD, LED or QLED screens, the background of the display is not illuminated. Rather, it is the individual pixels of the screen that produce light themselves. These are called Organic Light Emitting Diodes. The advantage here is that each point emits light and can be dimmed individually and independently of the neighboring point. OLED screens have advantages in that they can display actual black. With these screens, black is produced by switching off diodes, while LCD, LED and QLED screens are permanently irradiated.

The pixilated viewing screen (5) of the network (see FIG. 7a) can be a Mini LED (available from 2021) displays. Mini LED TVs are LCD or QLED TVs with more modern LED backlight technology. The mini-LEDs are about forty times smaller than traditional LEDs, which allows for brighter images and higher contrasts.

The quality of a pixilated viewing screen (5) enables further observation enhancements. The pixilated viewing screens (5) displays are available flat and curved. The number of pixels determines the resolution of the pixilated viewing screen (5) and the more pixels the clearer and sharper the image. Contrast and brightness are controlled by illumination control of the individual (red, green, and blue) pixels. An eight-bit illumination scale is a common standard. The number of pixels is calculated by multiplying the horizontal and vertical pixels. For example, HD (high definition) has 1920 horizontal and 1080 pixels and is known as 1080p viewing screen. The p stands for progressive scan. 4 K video resolution, for example has four times more pixels than full high definition (HD), and 8 K has sixteen times more pixels than 1080p. The pixel counts for the pixilated viewing screen (5) are important for a clear and sharp image. Furthermore, a high or ultra-high-definition pixilated viewing screen (5) will lend itself for optical magnification, and other image viewing modification with the pixilated viewing screen (5)

The three primary colors sequence blue, red, green make up the pixels count. Individual pixels have a chromatic illumination range of up to twelve bits. LED (light emitting diodes) and OLED (organic light emitting diodes) viewing screen pixels are self-illuminated. LCD (liquid crystal display) viewing screens are illuminated with white light and the color density can also be varied by up to twelve bits by voltage tension adjustments.

FIG. 8 shows an incorporated optical system for the welder's eyes (73 and 73a) to view the pixilated viewing screen (5). Also shown is the front of a helmet (13) for capturing images to project on to a pixilated image sensor (17) to be transmitted and permit viewing of welding on the pixilated viewing screen (5).

When viewing the pixilated viewing screen (5) the following dimensions should be considered. The viewing distance (72) from the eyes (73 and 73a) to the surface plane of the pixilated viewing screen (5) can be arbitrarily chosen to be 75 mm for the distance dimension (72). The pupillary distance or eye separation distribution in the human population is typically between 58 and 68 mm. See dimension (67). The eyes (73 and 73a) focal point distance (70) to the eye's retina of the eye lens (80) for most human eyes have a distribution that falls between 18 mm to 22 mm. The pupil (68) varies according to illumination—the brighter the illumination, the smaller the pupil diameter. See dimension (68) small sizes are a reaction to brightness and extend the field of depth. The vengeance angle's (71) variation for a large random population is between 21 to 25 degrees. Each of the welder's eyes (73 and 73a) will automatically align its vengeance to view the center of the pixilated viewing screen (5). This is shown as point (74) on the pixilated viewing screen (5). All adjustments the eye undertakes to improve the image projected to the retina have a lag time of approximately 0.2 seconds. Those five mentioned dimensions, closeness of screen (72), papillary distance (67), eye's retinal focal length, pupil diameter (68), and vengeance angle (71) for eyes (72 and 73) will be discussed in reference to FIGS. 8a, 8b and. 8c.

The protrusion (10) is part of insert (1) providing the cylindrical cavity for filters (9) including an adjustable liquid crystal filter (9 see FIG. 2b). The filter (9 see FIG. 2b) sandwiches liquid crystal material between two transparent filter plates (9a and 9c). The liquid crystal material (9b, 9c see FIG. 2a) reorients crystals in response to a voltage tension (potential) to adjust filtration density of the electromagnetic spectrum. Liquid crystal filters (9) limit illumination to adjust real time images to the dynamic range of the pixilated image sensor (17 see FIG. 4). Selective chromatic filtration for the primary colors blue, red, and green enhances picture quality for welding to selectively reducing chromatic image energy. The transparent disposable protector (8) is shown as part of the insert (1). Sensors (11) are part of the network (see FIGS. 3 and 7) used for data collection, subsequent real time image adjustment, and displaying of welding information on the pixilated viewing screen (5) (see FIGS. 3 and 7). An extension (6) is shown to provide the distance, dimension (72) needed for viewing the pixilated viewing screen (5) in high resolution. The flex circuit (64) conductor with the connector (75) form part of the pixilated viewing screen (5).

FIG. 8a is an isometric drawing showing eyeglasses (81) that compensate for the viewing stresses caused by the “close” proximity of a pixilated viewing screen (5) to the human eye.

For a welder to focus on a pixilated viewing screen (5) at a fixed short dimension (72) such as 75 mm, or less, with the eye approaching the limit of what a healthy human eye can focus on, an elevated level of focusing to approximately 13 diopters can cause strain and tire the eye. The same is true for the vengeance angle (71) (see FIG. 8). A pair of eyeglasses (81) specific toe welder's eyesight will render viewing a pixilated viewing screen (5) by the welder in comfort and safe from extended periods of strain. Individual selection of eyeglass lenses (82) and (82a) enables comfortable long time focusing and vengeance corrections attuned to the welder's eyes.

By providing at least one pre-manufactured eyeglasses (81) that is suitable to adjust close viewing for a large population of welders by incorporating diopter, and prismatic correction limits the eye's focusing and vengeance muscle strain. The pre-manufactured eyeglasses will enable comfortable and safe viewing for extended periods of the pixilated viewing screen (5). Individual specific eyeglasses (81) can address human-to-human variations (see FIG. 8). A single pair or a set of pre-manufactured eyeglasses will be limiting for some welder's eyesight.

Chromatic filters and additional magnification can be employed with the eyeglasses to improve the viewing of welding. Eye protection from the radiation of the pixilated viewing screen (5) can also be part of the eyeglasses such as a blue filter.

Magnifying the pixilated viewing screen (5) to view the small welding image are part of some customized or pre-manufactured eyeglasses (81). Lens assemblies and bifocal lenses will further the viewing of the pixilated viewing screen (5).

FIG. 8b is an isomeric drawing showing a welder with a right eye lens (84) and a left eye lens (84a) assembled to a right-side lens holder (85) and a left-side lens holder (85a) as part of the welding helmet (13), which permits the welder to view the pixilated viewing screen (5) inside the welding helmet (13). One of the lens holders (85) and (85a) contains a right-handed thread and the other a left-handed thread. A shaft with right-handed male threads (87) and a left-handed male thread can be rotated with the pupillary adjustment knob (89) to adjust the pupillary distance to the welder's eyes (73) and (73a). Clockwise rotation of the pupillary adjustment knob (89) brings the lens assemblies (92) and (92a) closer together. Similarly counterclockwise rotation of the knob (89) increases the distance between the lens assemblies (92) and (92a)

The lenses (84) and (84a) can be specific designs for the welder's eyesight for viewing the pixilated viewing screen (5) by the welder in comfort and safety for extended periods of time. The lenses (84) and (84a) have diopter corrections to view the close distance of dimension (72) (see FIG. 8) and prismatic corrections for the vengeance angle (71) (see FIG. 8). Magnification of the small welding arc plasma image on the pixilated viewing screen (5) with bifocal lenses can be incorporated with the lenses (84) and (84a) for that purpose.

At least one or more pre-manufactured lens assemblies (92) and (92a) suitable for a large population, will enable viewing the welding process by a large variation of welder's eyes. The lenses (84) and (84a), incorporate the ability of the welder's eyes focusing and vengeance angle adjustment motion (71) for comfortable viewing of the pixilated viewing screen (5). One or a set of pre-manufactured lenses (92) and (92a) enable comfortable and safe viewing by the welder for extended periods). Magnification to see the small welding arc plasma image on the pixilated viewing screen (5) can be accommodated with bifocal lenses. A track rail (86) is shown to keep the lenses parallel to the pixilated viewing screen (5). The connector (75) in the back of the pixilated viewing screen (5) connects with a flexible circuit conductor (64) to the printed circuit board (49 see FIG. 7). It is understood that alternate designs are possible in accordance with this invention to permit the viewing of the pixilated viewing screens with movable optics installed within helmets (13).

FIG. 8c is an isometric drawing that shows a flexure (92) embodiment which adjusts the distance (72) of a pixilated viewing screen (5). The flexure (92) shown next to the insert (1) is in a relaxed state. The same flexure (92) is shown in a flexed state with the attached viewing screen moved closer to the welder's eyes (73) and (73a). Two pads (93) with a right-handed thread and pad (94) with a left-handed thread are part of the flexure assembly (98) which also includes the flexure (92). A shaft (95) has a right-handed thread at the shaft at one end and a left-handed thread at the other end. The welder by rotating the drive knob (97) will squeeze the flexure (92) to force an expansion along line (12).

The flexure (92) is designed for stiffness in all directions except the direction of flexure along optical center line (12) and parallel to the welder's eye (73) and 73a). This flexure (92) will permit a welder to fine adjust the distance (72) between the welder's eyes (73) and (73a) and the pixilated viewing screen (5) for best individual focusing. The closer an object, like the pixilated viewing screen (5), is to the eye lens or any other focusing lens, large diopter corrections are needed to project a sharp image onto the welder's retina (70a see FIG. 8). The short distance (72 see FIG. 8) focused from the welder's eyes (73 and 73a) decreases the field of depth. Shorter, and shorter distances (72) require larger and larger +diopter correction. At seventy-five mm, the diopter requirement is +13, at 50 mm it rapidly increases to +20 diopters and a further shortening to 25 mm yields +40 diopters. Exponentially increasing to infinity and rendering the field of depth to be zero. This increase of lens power and the resulting squeezing of the field of depth is a function of distance. It demonstrates quite clearly how a movable pixilated viewing screen (5) will add with small distance (72) (see FIG. 8) to the welder's image resolution by small adjustments.

The welder's eyes (73) and welder eyeglasses (81) are shown at a distance (72) from the pixilated viewing screen (5). Also shown is the Centre point (74) of the pixilated viewing screen (5). Some welding helmets (13) have shields that pivot (13b) on a head band (13a). The up is unprotected viewing and down is protected for welding. The pivot (13a) provides a horizontal adjustment to alter the dimension (72) (see FIG. 8) to accommodate individual variations of the welder's eyes.

FIG. 8c) shows two flexure assemblies (98), once in a relaxed state, and the other is in a flexed state. The flexure (98) has two rectangular pads (96) in the flexure's (98) center. Those pads (96) are attached to one side to the insert (1) box (3) and on the other side of flexure's pad (96) attaches to the pixilated viewing screen (5). During flexure, the pixilated viewing screen (5 see FIG. 1) moves closer to the welder eyes. (73) and (73a).

After an image is captured and transmitted to a pixilated viewing screen (5 see FIG. 1) with an effective high pixel density, viewing will be improved. Using effective magnification eyeglasses or electronic magnification, the image will be improved. Also, chromatic filtering by the lenses can improve image quality.

The isomeric drawing (FIG. 9) shows the use of two dedicated lens barrel assemblies (99) to project an ambient, and another lens barrel assembly (100) to project the welding arc plasma images to two separate pixilated image sensors (17 see FIG. 4). In this embodiment the displayed images on the pixilated viewing screen (5 see FIG. 1) switches from ambient to welding images providing correct exposure for the ambient and the extreme bright welding plasma arc (110 see FIG. 7a) images. The image selection is initiated by the bright welding plasma arc (110 see FIGS. 7a and 7b).

In another optical embodiment both images from lens barrel (99) and (100), an embodiment where electronically processed sensor data superimpose a magnified welding plasma arc or weld puddle standard video on the ambient image. Alternative embodiment, with prismatic capture optics and a single pixelated image sensor (see FIG. 4 (17) or dual projecting optics with two pixelated image sensors to superimpose welding. dual projection projecting on or dual projecting optics projected and superimposed optically (prism) on to one pixilated image sensor (17 see FIG. 4). Dedicated optics is bridging the extreme exposure difference of the two images (ambient and welding plasma arc (110 see FIG. 7a) and superimposing the magnified welding image from lens barrel assembly (100) over the ambient image from lens barrel assembly (99). By keeping the image size within the welding plasma arc (110 see FIG. 7) resolvable illumination range the small, magnified image will show a detailed welding plasma arc image on top the ambient wide-angle images simultaneously.

With two separate pixilated image sensors (17 see FIG. 4) super imposing is accomplished with the process electronics ICs (integrated circuit 50 and 51), see FIG. 7). The dual electronic processing imaging approach for bridging the large image energy between ambient and the welding plasma arc advantages are by presenting the ambient image and the plasma arc simultaneously with independent process electronic frame rates, to present the welder an extreme dynamic range image by superimposing the plasma arc (110 see FIG. 7a) image over the ambient (still) images exceeding the image size of the welding plasma arc (110 see FIG. 7a) illumination range dependency.

By enabling separate optical capture embodiments for ambient and welding plasma arc (110 see FIG. 7a) as an alternate embodiment provides quality welding images without exposure compromises. The embodiment of the ambient lens barrel (99) for optimum ambient, brightness, contrast and resolution offer the option, to view the welding assembly the ambient image as maintaining the ambient information on the pixilated viewing screen with updates rates independent from the standard video imaging.

The optimum adjusted welding images of the plasma arc (110 see FIG. 7a) for detailed viewing is magnified and superimposed over the ambient image with frame rated independent from the ambient image updates and the standard video to enable showing and sensing the welding process in quality and detail. This separation of ambient or welding plasma arc (110 see FIG. 7a) exposure specific optical embodiments such as wide angle ambient and the magnified plasma arc (110 see FIG. 7a) image for superimposing on the wide-angle ambient image provides optimal viewing of the welding progress by showing, the welding plasma arc (110 see FIG. 7a) weld bubble through power pulsation, fusing quality, electronic sensing data, while communicating with the welder and network while integrate micro visual and motion adjustment beyond a welder's ability. Sensing the start of the welding arc plasma initiates electronics to start superimposing the welding plasma arc (110 see FIG. 7a) over the captured ambient (still) image. The flexibility of the two optical imaging systems (99 and 100) can improve image quality.

Different optical image capturing system embodiments allow for the ambient wide angle and magnified welding plasma arc (110 see FIG. 7a) image to be super superimposing with two dedicated pixilated imaging sensors (17) or the optical prismatic embodiment with one pixilated image sensor (17 see FIG. 4). Fixed or zoomed optical magnification of the welding plasma arc (110 see FIG. 7a) can enable detailed viewing of the welding plasma arc (110 see FIG. 7a) and the welding bubble by most people. Magnification will enlarge the capture area of the welding plasma arc (110 see FIG. 7a) decreasing pixel exposure.

Dedicated individual addressable pixels help will increase the dynamic range of the pixilated image sensor (17 see FIG. 4). Digital magnification expands the small portion of the welding plasma arc (11 see FIG. 7a) of the captured image and transmitted to the pixilated viewing screen (17). Large pixel counts on the pixilated image sensor (17) will enable larger magnification ratios.

The welding network with sensor information from the pixilated image sensor (17 see FIG. 4) and the sensor arrays (11 see FIG. 3) captures an ambient image with optical lens barrel assembly (99). When the welding plasma arc (110 see FIG. 7a) is ignited, the ambient imaging capture (99) is disabled, and the last ambient image frame is displayed from memory, included in IC (50 and 51 see FIG. 7), as a still picture on the pixilated viewing screen (5 see FIG. 1).

Capturing the magnified welding plasma arc (110 see FIG. 7a) image with the optical lens assembly (100) and adjusting exposure in real time for optimum image brightness, contrast, and sharpness. The in real time captured welding plasma arc (110 see FIG. 4) images with the pixilated image sensor (17 see FIG. 4) lens assembly (100) shows the progression of the welding plasma arc (110 see FIG. 7a) superimposed on the ambient still picture displayed on the pixilated viewing screen (5 see FIG. 1) for viewing by the welder. The image on the pixilated viewing screen (5 see FIG. 1) also presents to the welder real time sensor data, welding instructions, and electronically induced corrections for precise welding plasma arc (110 see FIG. 7a) gap distance and X, Y, and Z accuracy and motion speed adjustments for optimum welding. That position accuracy for the welding plasma arc (110 see FIG. 7a) is beyond a welder's ability. The network further function incorporates the real time adjustment of the welding power supply (48) with the information gathered from sensor array (11 see FIG. 3) and the pixilated image sensor (17 see FIG. 4)

An embodiment of the digital imaging system (99) for ambient illumination includes a wide-angle optical imaging system and at least one normal or wide-angle lens with a short focal length to yield sharp images from 10 mm to infinity. A 2 mm focal length lens, for example, will move the imaging plane by 0.4 mm for an object (such as the welding arc) 10 mm in front of the lenses focal point. The image resolution error of the projected object on the pixilated image sensor (17) with high f-number aperture (15 see FIG. 4) will not be noticeable by the welder viewing the image on the pixilated viewing screen (5). Short focal length lenses (19) eliminate the need for focus adjustments. Short focal length lenses have a huge focus advantage over human eyesight. The welder's eyes or any other human eye would require the retina to move 40 mm to focus on an object 10 mm in front of the eye's focus. As the retina cannot be adjusted, a +40 diopter lens can be used to focus images at 10 mm distance onto the eye's retina. The distance view for a healthy human eye (20/20 vision) stretches from 1000 mm to infinity, accepting a retina position error of 0.4 mm excluding the eye focusing adjustment of 15 diopters. Using the same blurring error to a 2 mm focal length lens results in stretching the field of view from 10 mm to infinity. It is part of this invention to bias the small image position error from the image plan towards infinity to further improved close-up resolution.

A small f-stop aperture (15 see FIG. 4)) (large opening) for indoor illumination with real time exposure adjustment that produces images that are well-balanced for contrast, brightness, and sharpness the frame rate of those captured images is independent from the welding plasma arc (110 see FIG. 7a) if still images are used the head motion can be compensated by one or more of motion detection; preselected filtering such as gray, polarizing, and color correction filters (9) can be added for different lightening conditions; digital real time exposure adjustments, during image capture can be program with sensor (11), or pixilated image sensor (17) information by the image processors (50) and (51); or digital editing, sharpness, contrast, and brightness can also be processed with the image processors (50) and (51)

By using a menu on the pixilated viewing screen (5), the welder can change factory settings by means of mechanical switches (58) (see FIG. 7) or a touch screen pixilated viewing screen (5) or a combination of both for adjust including, for example, pixel amplifications (ASA); pixel reading time (Shutter); digital gray scale and chromatic filters (9); digital image enhancement (sharpness, contrast, and brightness); or individual setting preferences such as screen brightness, starting, timing function, and data display.

The small sized welding plasma arc (110 see FIG. 7a) generates high energy images. Rapid exposure changes are a function of spherical surface expansion that require real time adjustment to view extreme dynamic range images The dynamic range of the pixilated image sensor (17) determines the illuminated area of the welding plasma arc (110 see FIG. 7a) that is viewable with correct brightness, contrast, and resolution. The low energy illumination of the surrounding (including the molten weld bubble material), will not be in range of the pixilated imaging sensor's (17) dynamic range. Magnification will enlarge the area or size around the welding arc plasma that is adjustable to the dynamic range of the pixilated image sensor (17). By turning the Welding plasma arc (110 see FIG. 7a) off, for a fraction, will render a detailed picture for viewing and analyzing the welding process.

The optical imaging system (100) for welding requires filters (9 see FIG. 2b), large f-stop aperture (15 see FIG. 4) numbers, and electronic control of the image capture, image editing, and digital and or optical magnification to present a high-quality image to use for welding.

Utilizing a digital liquid crystal filter (9) with f-stop's aperture (15) (see FIG. 2b) for exposure controlling the welding plasma arc images in a pixilated or configured liquid crystal filter (9) establishes the diameter and density of the f-stop aperture (15). The liquid crystal (9) uses coatings to provide gray, chromatic, polarized filtration, and electronic radiation protection. By turning the liquid crystal (9) on, an f-stops aperture (15) and aurora (9d) form. The filtration density of the f-stop aperture (15) and the aurora (9d) can be adjusted in real time to compensate for the large imaging energy variation from the arc distance changes to the imaging lens (19). A central circular f-stop aperture (15), and an illumination reducing aurora (9d) make up this version of a liquid crystal filter (9). Operating the liquid crystal filter (9) a f-stop variable aperture is responsive in real time to welding plasma arc (110 see FIG. 7a) exposure variations. A liquid crystal f-stop aperture (15) as a pixilated geometry that has a density adjustable aurora (9d see FIG. 2b), and f-stops aperture (15 see FIG. 4) will bridge large exposure changes in real time. The pixilated structure of the liquid crystal filter (9 see FIG. 2b) in addition to density adjustment additionally incorporates size selection of the aurora and the F-stop aperture to shift the dynamic range of images to be captured by the pixilated image sensor (17). Pixilated liquid crystal filters (9 see FIG. 2b) are operated with a pattered conductive transparent material such as indium tin oxide (9b see FIG. 2b). The individually formed pixels sandwich a liquid crystal material, to form the geometry of the f-stop aperture (15) and aurora (9d). A voltage tension (potential) selects liquid crystals pixel density filtering density. Different voltage tensions to the pixel's aurora (9d) and the f-stop's aperture (15) will offer wide f-stop aperture (15 see FIG. 4) and filtration control, such as, brightness and contrast with gray, chromatic, or polarizing filters (9) to control the welding plasma arc (110 see FIG. 7a) image energy to the dynamic range of the pixilated image sensor (17 see FIG. 4) in real time; brightness and contrast with shutter speed and frame rate; local individual real time pixel adjustment for extreme illumination during image capture to extend the dynamic range of the pixilated image sensor (17 see FIG. 4); or real time f-stop aperture (15) and aurora geometry and size selection.

Reading single pixel exposure from the welding arc and individually adjusted them with the image processors ICs (integrated circuit) during image capture will extend the dynamic range of a pixilated imaging sensor (17) to transmit welding images with high-quality, contrast and brightness on a pixilated viewing screen (5). The extended dynamic range will include a large area of the welding arc plasma surrounding to be part of the image. Editing sharpness, contrast, brightness, gray scale, and chromatic filtering can be effectively selected based on the welding application.

A disposable rectangular transparent protector (8) part to the protrusion (105) will protect the imaging system (99) and (101) from welding splatter. By using 7 nano-meter IC (integrated circuit) technology, to enable high frame video and low amplification can produce a video image within a dynamic range of the pixilated image sensor (17) without resorting to filters (9). Using two dedicated imaging systems (99) and (100) can reduce complexity to bridge the extreme energy difference between the ambient and the welding plasma arc (110 see FIG. 7a) image. Ambient exposure captures are known technology for low light conditions. This invention will overcome the difficulties of showing the welding plasma arc (110 see FIG. 7a) images with multimillion times the energy of an ambient image simultaneously. Two separate imaging capture systems (99) and (100) with image rate independence permit viewing of the ambient and welding arc plasma images simultaneously.

By practicing the real time network functions described herein, welding quality can be improved. Carefully selecting the image gathering function can be used to significantly improve the quality of the weld. Using electronic sensor monitoring of the welding process as described herein will improve welding quality and consistency, augment human limitations, or facilitate welding automation.

By using the present invention, the enormous image energy difference with a ratio in the hundreds of millions between ambient and welding arc plasma can be bridged. In FIG. 4, single lens barrel approaches are presented that provide solutions to bridge this energy gap problem.

By properly selecting an effective pixilated image sensor (17), the dynamic range of the pixilated image sensor (17) can be enlarged and shifted to the high energy side. Other features of the present invention include thermal filtering to protect CCD and CMOS pixilated image sensors (17); gray scale filtering for radiation energy absorption; chromatic filtering to absorb narrow or specific radiation that overpowers an image; electronic magnification, optical magnification, or a combination thereof, can be used to enlarge the welding arc plasma image for viewing during welding to improve weld quality. The present invention is suitable for use in conjunction with other welding processes.

According to another example embodiment of the invention, the processing electronics of the welding system includes artificial intelligence for analyzing the welding scene in real time and provides information related to the welding scene. In other example embodiments, the welding system includes an image sensor with the processing electronics providing real time viewing of the welding scene on the image sensor. The processing electronics includes artificial intelligence, for example, an AI chip included with the processing electronics or connected via a network, for controlling the information related to the welding scene. The processing electronics can control the controlled device to adjust the weld based on the analysis of the welding scene. Network examples include, but are not limited to, wired, wireless, LAN, or cloud based. The welding system can include a controlled device responsive to the processing electronics for automatically adjusting a weld provided in the welding scene image.

FIG. 122 represents a data center where welding data, for example, from a multitude of networks is recorded and analyzed for (AI) intelligent utilization of such collected welding data. The collected data in networks combined enables the history (experiences) of welding to be available to benefit all welding connected to this data processing center. Further, this data center can provide standard videos to a welder that are fabricated to provide images of welding in detail assisting a welder. As shown, aa AI (artificial intelligence) control system permits the real time adjustments of the weld in the welding scene. As the AI system can learn from experience by analyzing information related to the welding scene, it can provide continuous improvement of the weld.

Throughout the specification and claims, the following terms take the meanings explicitly associated herein, unless the context clearly dictates otherwise. The meaning of “a,” “an,” and “the” includes plural reference, the meaning of “in” includes “in” and “on.” Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The invention has been described in detail with particular reference to certain preferred embodiments thereof, but it will be understood that variations and modifications can be affected within the scope of the invention. The embodiments described above can be implemented individually or in combination with each other to obtain the desired performance.

### FIGS. 1 & 1a (Insert Welders View)

1) Insert, (lid, Box, and screen)
2) open
3) Box
4) Lid
5) Pixelated viewing screen
6) Extension (for eye/screen distance)
7) Insert frame (fits Liquid crystal filter slot)

### FIGS. 2 & 2a

8) Disposable transparent protector
9) Filter (liquid crystal and other filters)
9a) passive glass disk (FIG. 2b)
9b) passive indium oxide coating (FIG. 2b)
9c) active glass disk protector and filters
9d) active indium oxide coating (aurora)22
9e) Liquid crystal f-stop aperture
9f) liquid crystal aurora
10) Protrusion (front toward weld)

### FIGS. 3 & 3a

11) Sensor array
12) Optical center line, 12
13) Welding helmet or face shield,
13a) headband,
13b) pivot
13c) wireless communication antenna

### FIG. 4

14) Front of spherical lens assembly
15) f-stops aperture
16) depression for pixelated Image sensor
17) Pixelated image sensor
18) Flex circuit (pixelated image sensor)
19) Imaging lens, or lenses
20 Back of spherical lens barrel (toward welder's eyes)
21 Spherical lens barrel assembly
22 image transmission aperture
23 Inside protrusion on lid
24 Spherical impression on inside protrusion

### FIG. 5

25 Cavity for transparent disposable protector and filters
26 Actuator drive link
27 Actuator Gear box
28 Actuator motor
29 Actuator drive screw
30 Actuator assembly (x tilt)
30a Actuator assembly (Y tilt)
31 “X” translation plate horizontal (lens barrel tilting)
32 “Y” translation plate vertical lens barrel tilting.
33 spherical drive pin
34 cylindrical drive hole
35 Flat wave spring

### FIG. 5a

36 Insert extrusion
37 Filter/aperture wheel
38 Actuator for filter/aperture selection

### FIG. 5b

39 pivot for filter wheel.
40 motor
41 gear box
42 pinion gear

### FIG. 6

43 disposable transparent protector holder
44 open

### FIG. 6a

45 Square protrusion
46 square disposable transparent protector
47 Small aperture through square protrusion

### FIG. 7

48 Welding power supply.
48a open
49 Printed circuit board (processor)
50 integrated image processing circuit
51 integrated image processing circuit
53c fixed lens
53d collimator element
54 ray trace
55 Micro processer IC
56 Liquid crystal driver IC
57 Zoom driver IC
58 menu selector switches
59 wireless communication IC
59a antenna for wireless communication
60 micro-C connector
60a USB connector
60b SD memory card
61 spectrum energy collector
62 rechargeable battery
63 head band switch
64 face shield down switch
65 Sensor Interface IC
66 welder communication

### FIG. 7a

106 Stick welding method
107 Tungsten inert gas welding method
108 GMAW (MIG) inert gas metal arc welding method
109 Laser welding method
110 Plasma arc
111 Laser plasma arc

### FIG. 7b

114 plasma arc gap
115 Weld stick
115a weld protection coating
115b metal base and electrode
117 Gear box
118 drive motor
119 encoder
120 welding handle
121 power cord
122 Communal recording and processing center for AI. (artificial intelligence) see FIGS. 7b, and 3a

### FIG. 8

67 Dimension; Pupillary distance
68 Dimension; pupillary diameter (eye aperture)
69 Eye point of focus
70 Dimension; distance of eye lens focus
71 Dimension: Vesicular angle
72 Dimension: screen from eye focal point
73 right eye
73 a left eye
74 center point of screen 75 flex circuit connector 76 open
77 open
78 open
79 open
80 eye lens

### FIG. 8a

81 Eyeglasses
82 Eyeglasses right lens
82a Eyeglasses left lens.
83 beam direction after lens correction

### FIG. 8b

84 right side lens
84a left side lens.
85 right side lens holder
85a left side lens holder.
86 lens rail
87 pupillary drive shaft
88 bearing for pupillary drive shaft
89 drive knob for pupillary drive shaft
90 right-handed tread
91 left-handed thread
92 right hand lens assembly
92a left hand lens assembly.

### FIG. 8c

92 Flexure for linear screen adjustment
93 left side contraction pad
94 right side contraction pad
95 adjustment shaft
96 flexure mounting pad
97 Adjustment knob
98 flexure assembly

### FIG. 9

99 Ambient lens assembly
100 welding arc imaging lens assembly
101 filter opening
102 disposable transparent protector
103 aperture forming liquid filter.
104 ambient filter
104a opening for filter
105 multiple lens disposable transparent Protector
122 Communal data centre

1. A welding network comprising:
Processing electronics to manage a welding network and furthermore connect to a community of welding networks with a data center (cloud) and artificial intelligence to manage welding.

2. The welding network of claim 1 comprising; processing electronics means to manage data capture of a welding scene, means for data analysis to operate the welding network, and produce an unobstructed observable standard video of welding to be displayed on a viewing screen for welding.

3) The welding network of claim 1 further comprising; short focal length image projection optics and a pixelated image sensor for capturing-data.

4) The welding network of claim 3 embodiments of short focal length projection optics
with electronic processing control;
d) actuators to bridge the exposure difference between ambient and welding plasma arc.
e) exposure biased projection optic controlled with electronic processing controlling amplification and read speed.
f) Electronic processing control for imaging and data gathering unobstructed from the 4 Kelvin welding plasma arc. Electronic processing enabling observation of the molten welding puddle.
g)

5) The welding network of claim 1 where process electronics analyzing the collected data to set up and operate the welding network for automation and instructing a welder with a fabricated standard video.

6) The welding network of claim 1 where process electronics communicates with the data center to benefit from communal data and artificial intelligence.

7) The welding network according to claim 2, further comprising:
controlling devices responsive to processing electronics for automatically adjusting welding setup and real time welding operation.

8) The welding network according to claim 1, further comprising electronic processing of weld tracking.

9) The welding system according to claim 1, further comprising:
a helmet worn by a welder, the helmet includes network connection, a viewing screen viewable by the welder, the screen displays a data fabricated standard video including welding information of the welding scene.

10) The welding system of claim 9, further comprising:
means for protecting the welder and electronics by managing welding radiation and material splatter common to welding.

11) The welding network of claim 1, further comprising:
Wired and wireless network connectivity

12) The welding network of claim 2, further comprising:
means to electronically process sensor data superimpose a magnified plasma arc or weld puddle standard video on the ambient image.

13) The welding network of claim 12, further comprising;
Prismatic capture optics and a single pixelated image sensor (17 see FIG. 4, or dual projection optics and image sensors means to superimpose welding images.

14) The welding network of claim 1, wherein the electronics processing includes means for assisting the welder's limitation of sight and motion with means for analyzing welding position and speed to instruct the welder for weld speed and motion geometry.

15) The welding network of claim 1, wherein the gap between a welding electrode and the welding material is controlled by sensor data and the processing electronics.

16) The welding network of claim 1, wherein the processing electronics includes means for capturing image data information on a requirement basis for updating imaging and data to fabricate the standard video for viewing an unobstructed t welding scene.

17) The welding network of claim, wherein the processing electronic captures sensor data on a requirement basis for accurate and proficient operation of the welding network.
